(19) United States
(12) Patent Application Publication
(10) Pub. No.: US 2021/0294091 A1
(43) Pub. Date: Sep. 23, 2021

(54) DISPLAY APPARATUS

(71) Applicant: SONY CORPORATION, TOKYO (JP)

(72) Inventors: MITSUHARU MATSUMOTO, TOKYO (JP); MAMORU SUZUKI, TOKYO (JP); SUSUMU ICHIKAWA, TOKYO (JP); TAKATOSHI MATSUYAMA, TOKYO (JP); MASATOSHI NAKAMURA, TOKYO (JP)

(21) Appl. No.: 17/250,433

(22) PCT Filed: Jul. 17, 2019
(86) PCT No.: PCT/JP2019/028102

§ 371 Date: Jan. 20, 2021

(30) Foreign Application Priority Data
Jul. 31, 2018 (JP) 2018-143853

(51) Int. Cl. G02B 25/00; G02B 13/18; G02B 9/12; G02B 9/34

(52) U.S. Cl. CPC G02B 25/001; G02B 9/34; G02B 9/12; G02B 13/18

(57) ABSTRACT

A display apparatus of the present disclosure includes an eyepiece display unit including an image display device and an eyepiece optical system that guides a display image displayed on the image display device to an eye point, in which an image magnification by the eyepiece optical system is twice or more, the eyepiece optical system is a coaxial system including a plurality of single lenses, at least one of the plurality of single lenses is an aspherical lens including a resin material, and the image display device displays, as the display image, an image for correction of distortion and chromatic aberration of magnification generated in the eyepiece optical system.

### TECHNICAL FIELD

The present disclosure relates to a display apparatus suitable for a head-mounted display, etc.

### BACKGROUND ART

As a display apparatus using an image display device, an electronic viewfinder, an electronic binocular, a head-mounted display (HMD), etc. are known. In particular, the head-mounted display is used for a long period of time with a body of the display apparatus being worn in front of one's eyes. It is therefore required that an eyepiece optical system and the body of the display apparatus be small-sized and light-weighted. In addition, it is required that an image be observable at a wide field angle of view and at a high magnification. An eyepiece optical system described in PTL 1 attains an optical system that achieves both high resolution and high magnification by using a plurality of lenses including a glass material having a high refractive index and high Abbe's number.

### CITATION LIST

### Patent Literature

PTL 1: Japanese Unexamined Patent Application Publication No. H11-23984

### SUMMARY OF THE INVENTION

Using the glass material having a high refractive index and high Abbe's number leads to use of a glass lens having a high density, thus making the optical system heavy.

It is desirable to provide a display apparatus that makes it possible to provide high-definition beauty of an image while achieving a lighter weight and a wider angle of view.

A display apparatus according to an embodiment of the present disclosure includes an eyepiece display unit including an image display device and an eyepiece optical system that guides a display image displayed on the image display device to an eye point, in which an image magnification by the eyepiece optical system is twice or more, the eyepiece optical system is a coaxial system including a plurality of single lenses, at least one of the plurality of single lenses is an aspherical lens including a resin material, and the image display device displays, as the display image, an image for correction of distortion and chromatic aberration of magnification generated in the eyepiece optical system.

The display apparatus according to an embodiment of the present disclosure includes the eyepiece optical system of a coaxial system including a plurality of single lenses, thus optimizing the configuration of the single lenses. The image display device displays a display image for correction of distortion and chromatic aberration of magnification generated in the eyepiece optical system.

### BRIEF DESCRIPTION OF THE DRAWINGS

FIG. 1 is an explanatory diagram illustrating a first configuration example of an eyepiece display unit used in a head-mounted display, for example.

FIG. 2 is an explanatory diagram illustrating a second configuration example of the eyepiece display unit used in the head-mounted display, for example.

FIG. 3 is an explanatory diagram of image magnification.

FIG. 4 is a plan view of an overview of a display apparatus according to an embodiment of the present disclosure.

FIG. 5 is a side view of an overview of the display apparatus according to an embodiment.

FIG. 6 is an explanatory diagram illustrating a correspondence relationship between an output image to an image display device and an image actually visible through an eyepiece optical system having distortion.

FIG. 7 is an explanatory diagram illustrating a correspondence relationship between an output image to an image display device and an image actually visible through an eyepiece optical system having chromatic aberration of magnification.

FIG. 8 is an explanatory diagram illustrating an ideal light beam reaching position in an optical system of a focal length f and a light beam reaching position (an actual light beam reaching position) distorted by generation of distortion.

FIG. 9 is an explanatory diagram schematically illustrating an ideal light beam reaching position and an actual light beam reaching position in a case where marginal light beams are aligned and an amount of deviation between the ideal light beam reaching position and the actual light beam reaching position.

FIG. 10 is an explanatory diagram schematically illustrating ideal reaching positions of light beam of a plurality of colors.

FIG. 11 is an explanatory diagram schematically illustrating light beam reaching positions of a plurality of colors varied due to generation of chromatic aberration of magnification.

FIG. 12 is an explanatory diagram illustrating a green spectrum of a typical image display device.

FIG. 13 is an explanatory diagram illustrating a correlation between chromatic aberration of magnification generated in an optical system and an amount of deviation between light beam reaching positions of a short-side wavelength of a green color and a long-side wavelength of the green color in a case where only the green color is emitted.

FIG. 14 is an explanatory diagram schematically illustrating a relationship between magnitude of a field angle of view (FOV) as well as magnitude of an eye relief (E.R.) and a height of a light beam passing an outermost of a first surface of an eyepiece.

FIG. 15 is a cross-sectional view of lenses of an eyepiece according to Example 1.

FIG. 16 is an aberration diagram illustrating spherical aberration of the eyepiece according to Example 1.

FIG. 17 is an aberration diagram illustrating field curvature and distortion of the eyepiece according to Example 1.

FIG. 18 is an aberration diagram illustrating chromatic aberration of magnification of the eyepiece according to Example 1.

FIG. 19 is a cross-sectional view of lenses of an eyepiece according to Example 2.

FIG. 20 is an aberration diagram illustrating spherical aberration of the eyepiece according to Example 2.

FIG. 21 is an aberration diagram illustrating field curvature and distortion of the eyepiece according to Example 2.

FIG. 22 is an aberration diagram illustrating chromatic aberration of magnification of the eyepiece according to Example 2.

FIG. 23 is a cross-sectional view of lenses of an eyepiece according to Example 3.

FIG. 24 is an aberration diagram illustrating spherical aberration of the eyepiece according to Example 3.

FIG. 25 is an aberration diagram illustrating field curvature and distortion of the eyepiece according to Example 3.

FIG. 26 is an aberration diagram illustrating chromatic aberration of magnification of the eyepiece according to Example 3.

FIG. 27 is a cross-sectional view of lenses of an eyepiece according to Example 4.

FIG. 28 is an aberration diagram illustrating spherical aberration of the eyepiece according to Example 4.

FIG. 29 is an aberration diagram illustrating field curvature and distortion of the eyepiece according to Example 4.

FIG. 30 is an aberration diagram illustrating chromatic aberration of magnification of the eyepiece according to Example 4.

FIG. 31 is a cross-sectional view of lenses of an eyepiece according to Example 5.

FIG. 32 is an aberration diagram illustrating spherical aberration of the eyepiece according to Example 5.

FIG. 33 is an aberration diagram illustrating field curvature and distortion of the eyepiece according to Example 5.

FIG. 34 is an aberration diagram illustrating chromatic aberration of magnification of the eyepiece according to Example 5.

FIG. 35 is a cross-sectional view of lenses of an eyepiece according to Example 6.

FIG. 36 is an aberration diagram illustrating spherical aberration of the eyepiece according to Example 6.

FIG. 37 is an aberration diagram illustrating field curvature and distortion of the eyepiece according to Example 6.

FIG. 38 is an aberration diagram illustrating chromatic aberration of magnification of the eyepiece according to Example 6.

FIG. 39 is a cross-sectional view of lenses of an eyepiece according to Example 7.

FIG. 40 is an aberration diagram illustrating spherical aberration of the eyepiece according to Example 7.

FIG. 41 is an aberration diagram illustrating field curvature and distortion of the eyepiece according to Example 7.

FIG. 42 is an aberration diagram illustrating chromatic aberration of magnification of the eyepiece according to Example 7.

FIG. 43 is a cross-sectional view of lenses of an eyepiece according to Example 8.

FIG. 44 is an aberration diagram illustrating spherical aberration of the eyepiece according to Example 8.

FIG. 45 is an aberration diagram illustrating field curvature and distortion of the eyepiece according to Example 8.

FIG. 46 is an aberration diagram illustrating chromatic aberration of magnification of the eyepiece according to Example 8.

FIG. 47 is a cross-sectional view of lenses of an eyepiece according to Example 9.

FIG. 48 is an aberration diagram illustrating spherical aberration of the eyepiece according to Example 9.

FIG. 49 is an aberration diagram illustrating field curvature and distortion of the eyepiece according to Example 9.

FIG. 50 is an aberration diagram illustrating chromatic aberration of magnification of the eyepiece according to Example 9.

FIG. 51 is a cross-sectional view of lenses of an eyepiece according to Example 10.

FIG. 52 is an aberration diagram illustrating spherical aberration of the eyepiece according to Example 10.

FIG. 53 is an aberration diagram illustrating field curvature and distortion of the eyepiece according to Example 10.

FIG. 54 is an aberration diagram illustrating chromatic aberration of magnification of the eyepiece according to Example 10.

FIG. 55 is a cross-sectional view of lenses of an eyepiece according to Example 11.

FIG. 56 is an aberration diagram illustrating spherical aberration of the eyepiece according to Example 11.

FIG. 57 is an aberration diagram illustrating field curvature and distortion of the eyepiece according to Example 11.

FIG. 58 is an aberration diagram illustrating chromatic aberration of magnification of the eyepiece according to Example 11.

FIG. 59 is a cross-sectional view of lenses of an eyepiece according to Example 12.

FIG. 60 is an aberration diagram illustrating spherical aberration of the eyepiece according to Example 12.

FIG. 61 is an aberration diagram illustrating field curvature and distortion of the eyepiece according to Example 12.

FIG. 62 is an aberration diagram illustrating chromatic aberration of magnification of the eyepiece according to Example 12.

FIG. 63 is a cross-sectional view of lenses of an eyepiece according to Example 13.

FIG. 64 is an aberration diagram illustrating spherical aberration of the eyepiece according to Example 13.

FIG. 65 is an aberration diagram illustrating field curvature and distortion of the eyepiece according to Example 13.

FIG. 66 is an aberration diagram illustrating chromatic aberration of magnification of the eyepiece according to Example 13.

FIG. 67 is a cross-sectional view of lenses of an eyepiece according to Example 14.

FIG. 68 is an aberration diagram illustrating spherical aberration of the eyepiece according to Example 14.

FIG. 69 is an aberration diagram illustrating field curvature and distortion of the eyepiece according to Example 14.

FIG. 70 is an aberration diagram illustrating chromatic aberration of magnification of the eyepiece according to Example 14.

FIG. 71 is a cross-sectional view of lenses of an eyepiece according to Example 15.

FIG. 72 is an aberration diagram illustrating spherical aberration of the eyepiece according to Example 15.

FIG. 73 is an aberration diagram illustrating field curvature and distortion of the eyepiece according to Example 15.

FIG. 74 is an aberration diagram illustrating chromatic aberration of magnification of the eyepiece according to Example 15.

FIG. 75 is a cross-sectional view of lenses of an eyepiece according to Example 16.

FIG. 76 is an aberration diagram illustrating spherical aberration of the eyepiece according to Example 16.

FIG. 77 is an aberration diagram illustrating field curvature and distortion of the eyepiece according to Example 16.

FIG. 78 is an aberration diagram illustrating chromatic aberration of magnification of the eyepiece according to Example 16.

FIG. 79 is a cross-sectional view of lenses of an eyepiece according to Example 17.

FIG. 80 is an aberration diagram illustrating spherical aberration of the eyepiece according to Example 17.

FIG. 81 is an aberration diagram illustrating field curvature and distortion of the eyepiece according to Example 17.

FIG. 82 is an aberration diagram illustrating chromatic aberration of magnification of the eyepiece according to Example 17.

FIG. 83 is a cross-sectional view of lenses of an eyepiece according to Example 18.

FIG. 84 is an aberration diagram illustrating spherical aberration of the eyepiece according to Example 18.

FIG. 85 is an aberration diagram illustrating field curvature and distortion of the eyepiece according to Example 18.

FIG. 86 is an aberration diagram illustrating chromatic aberration of magnification of the eyepiece according to Example 18.

FIG. 87 is an external perspective view of a head-mounted display as an example of a display apparatus as viewed obliquely from the front.

FIG. 88 is an external perspective view of the head-mounted display as an example of the display apparatus as viewed obliquely from the rear.

### MODES FOR CARRYING OUT THE INVENTION

Hereinafter, description is given in detail of embodiments of the present disclosure with reference to the drawings. It is to be noted that the description is given in the following order.

### 0. Comparative Example

1. Description of Display Apparatus according to Embodiment

1.1. Overview of Display Apparatus according to Embodiment

1.2. Description of Correction of Distortion and Chromatic Aberration of Magnification

### 2. Configuration Example and Workings and Effects of Eyepiece Optical System (Eyepiece)

### 3. Example of Application to Head-Mounted Display

### 4. Numerical Examples of Eyepiece Optical System (Eyepiece)

### 5. Other Embodiments

### 0. Comparative Example

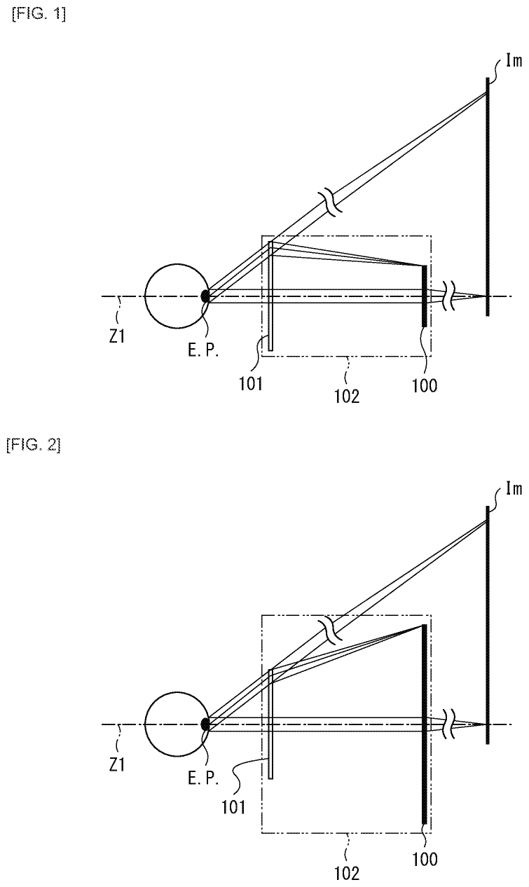

FIG. 1 illustrates a first configuration example of an eyepiece display unit 102 used in a head-mounted display, for example. FIG. 2 illustrates a second configuration example of the eyepiece display unit 102 used in the head-mounted display, for example.

The eyepiece display unit 102 includes an eyepiece optical system 101 and an image display device 100 in order from side of an eye point E.P. along an optical axis Z1.

The image display device 100 is, for example, a display panel such as an LCD (Liquid Crystal Display) or an organic EL display. The eyepiece optical system 101 is used to magnify and display an image displayed on the image display device 100. The eyepiece optical system 101 is configured by, for example, an eyepiece including a plurality of lenses. With use of the eyepiece optical system 101, an observer observes a virtual image Im that is displayed in a magnified manner. A sealing glass, etc. adapted to protect the image display device 100 may be disposed on a front surface of the image display device 100. The eye point E.P. corresponds to a position of a pupil of the observer and also serves as an aperture stop STO.

Here, FIG. 1 illustrates a configuration example in a case where a size of the image display device 100 is smaller than a diameter of the eyepiece optical system 101. FIG. 2 illustrates a configuration example in a case where the size of the image display device 100 is large than the diameter of the eyepiece optical system 101.

In a head-mounted display having a high viewing angle with a field angle of view over 70° and using the coaxial eyepiece optical system 101, the image display device 100 is often larger than the diameter of the eyepiece optical system 101. In such a head-mounted display, an image magnification Mv is suppressed to be small, but a focal length f becomes relatively long. This leads to a concern that the eyepiece optical system 101 has a long total length. In addition, the size of the eyepiece optical system 101 is sometimes limited not by the size of the eyepiece optical system 101 but by the size of the image display device 100. This further leads to an issue of unsuitableness for a reduction in size.

For example, as illustrated in FIG. 1, in a case where the size of the image display device 100 is small, the size of the entire eyepiece display unit 102 is limited by the size of the eyepiece optical system 101. In contrast, as illustrated in FIG. 2, in a case where the size of the image display device 100 is large, the size of the entire eyepiece display unit 102 is limited by the size of the image display device 100.

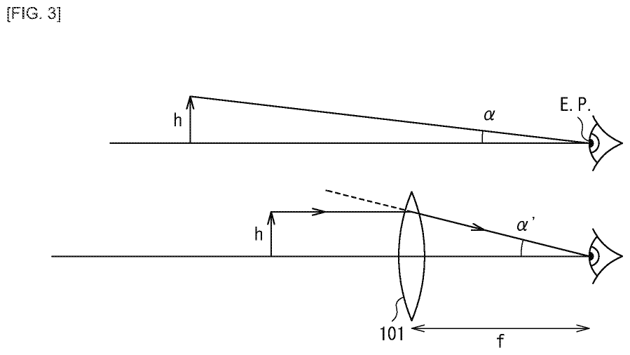

It is to be noted that the image magnification Mv is expressed by Mv=α′/α. As illustrated in the upper part of FIG. 3, α denotes a field angle of view in a case where the eyepiece optical system 101 is not provided. In addition, as illustrated in a lower part of FIG. 3, α′ denotes a field angle of view (field angle of view with respect to the virtual image Im) in a case where the eyepiece optical system 101 is provided. In FIG. 3, h is a maximum image height of an image to be observed, and is, for example, a maximum image height of an image displayed on the image display device 100. For example, in a case where the image display device 100 has a rectangular shape, h is a half value of a diagonal size of the image display device 100. f denotes a focal length of the eyepiece optical system 101.

In addition, the image magnification Mv is expressed by the following expression (A):

Mv=ω′(tan⁻¹(h/L)) (A)

where

ω′ is a half value (rad) of a maximum field angle of view,

h is a maximum image height, and

L is a total length (a distance from the eye point E.P. to an image).

It is to be noted that the image refers to an image displayed on the image display device 100, for example. For example, in the case where the image display device 100 has the rectangular shape, h is the half value of the diagonal size of the image display device 100, as described above. L corresponds to the total length of the eyepiece optical system 101 described above (a distance from the eye point E.P. to a display surface of the image display device 100), for example.

In the head-mounted display having a high viewing angle with a field angle of view over 70°, using the image display device 100 having a small size relative to the diameter of the eyepiece optical system 101 as in the configuration example in FIG. 1 enables reduction in the total length and size of the eyepiece optical system 101 as compared with the case of using the image display device 100 having a large size. This is believed to contribute advantageously to a reduction in size of the head-mounted display. However, in a case of attempting to achieve such a head-mounted display using the coaxial eyepiece optical system 101, there is an issue of difficulty in increasing the image magnification Mv when attempting to increase an image-forming capability.

One of measures to improve the above issue is a method of using a plurality of glass materials having a high refractive index and high Abbe's number as lenses that configure the eyepiece optical system 101. PTL 1 (Japanese Unexamined Patent Application Publication No. H11-23984) uses this method to thereby attain the eyepiece optical system 101 that achieves both high resolution and high magnification. However, this method involves using a glass lens having a high density, thus making the eyepiece optical system 101 heavy.

It is therefore desired to develop a display apparatus suitable for the head-mounted display, etc. that makes it possible to achieve a lighter weight and a wider angle of view and to provide high-definition beauty of an image.

### 1. Description of Display Apparatus According to Embodiment

### [1.1. Overview of Display Apparatus According to Embodiment]

A display apparatus according to an embodiment of the present disclosure is applicable to the head-mounted display, for example.

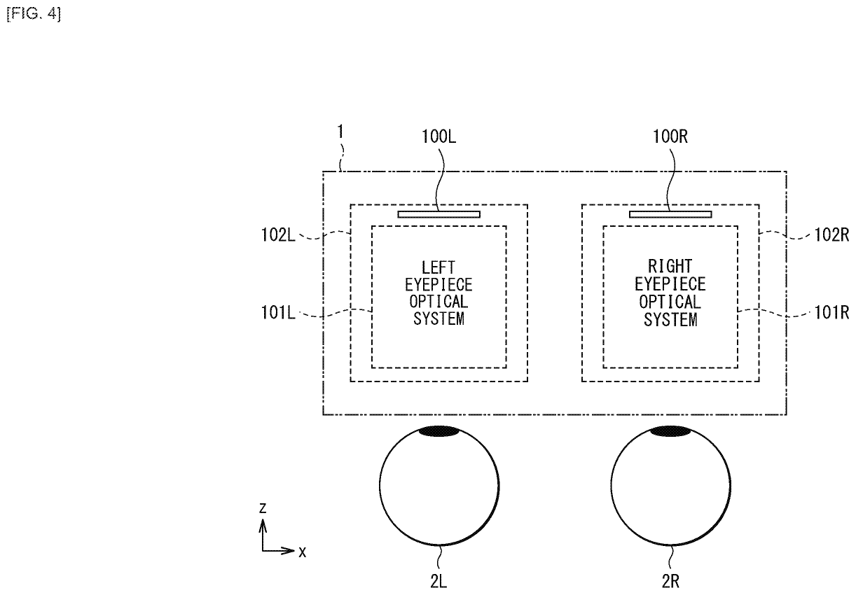

FIGS. 4 and 5 each illustrate an overview of a display apparatus 1 according to an embodiment of the present disclosure. FIG. 4 illustrates a configuration of the display apparatus 1 in an x-z plane. FIG. 5 illustrates a configuration of the display apparatus 1 as viewed from a side surface (y-z plane).

As illustrated in FIGS. 4 and 5, the display apparatus 1 includes a left eyepiece display unit 102L and a right eyepiece display unit 102R arranged side by side at positions corresponding to locations of both eyes. The display apparatus 1 is configured to allow the image magnification My to be twice or more upon observation by both eyes.

Inside the left eyepiece display unit 102L, there are arranged a left-eye image display device 100L and a left eyepiece optical system 101L that guides a left-eye display image displayed on the left-eye image display device 100L to a left eye 2L.

Inside the right eyepiece display unit 102R, there are arranged a right-eye image display device 100R and a right eyepiece optical system 101R that guides a right-eye display image displayed on the right-eye image display device 100R to a right eye 2R.

Each of the left eyepiece optical system 101L and the right eyepiece optical system 101R is configured by an eyepiece including a plurality of single lenses. Each of the left eyepiece optical system 101L and the right eyepiece optical system 101R is a coaxial system, and is configured to allow the image magnification by each system (single eye) is twice or more.

In the left eyepiece optical system 101L and the right eyepiece optical system 101R, at least one of the plurality of single lenses is an aspherical lens including a resin material. Employing a resin material for at least one of the plurality of single lenses makes it possible to reduce weights of the left eyepiece optical system 101L and the right eyepiece optical system 101R. In addition, employing the aspherical lens for at least one of the plurality of single lenses makes it possible to suppress generation of aberration.

Each of the left-eye image display device 100L and the right-eye image display device 100R is configured by, for example, a flat-type small display panel such as an LCD and an organic EL display.

In a case where the display apparatus 1 is applied to a head-mounted display, or the like, usually, the same image is displayed, as a left-eye display image and a right-eye display image, in the left-eye image display device 100L and the right-eye image display device 100R, and the same image is observed in the left eye 2L and the right eye 2R. As a result, when viewed by both eyes, an image is observed at the same angle of view as the field angle of view in a single eye.

The left-eye image display device 100L displays, as the left-eye display image, an image for correction of distortion and chromatic aberration of magnification generated in the left eyepiece optical system 101L. Similarly, the right-eye image display device 100R displays, as the right-eye display image, an image for correction of distortion and chromatic aberration of magnification generated in the right eyepiece optical system 101R.

This enables the distortion and the chromatic aberration of magnification generated in the left eyepiece optical system 101L and the right eyepiece optical system 101R to be allowed to some extent, and enables the left eyepiece optical system 101L and the right eyepiece optical system 101R to substantially achieve high magnification and a reduction in weight of the optical system while maintaining an appearance not different from that in a case where the distortion and the chromatic aberration of magnification are not generated.

### [1.2. Description of Correction of Distortion and Chromatic Aberration of Magnification]

In the following, description is given of specific examples of corrections of distortion and chromatic aberration of magnification by a left-eye display image and a right-eye display image displayed by the left-eye image display device 100L and the right-eye image display device 100R. The method for correction of the image displayed on the left-eye image display device 100L and the right-eye image display device 100R are substantially the same between the left and the right, and thus the left-eye image display device 100L or the right-eye image display device 100R is hereinafter referred to as the image display device 100 without distinction between the left and the right. Similarly, the left eyepiece optical system 101L or the right eyepiece optical system 101R is referred to as the eyepiece optical system 101 without distinction between the left and the right. Similarly, the left-eye display image or the right-eye display image is referred to as a display image without distinction between the left and the right. Further, similarly, also in other descriptions below, the descriptions are given as appropriate without distinction between the left and the right as needed.

### (Correction of Distortion and Chromatic Aberration of Magnification)

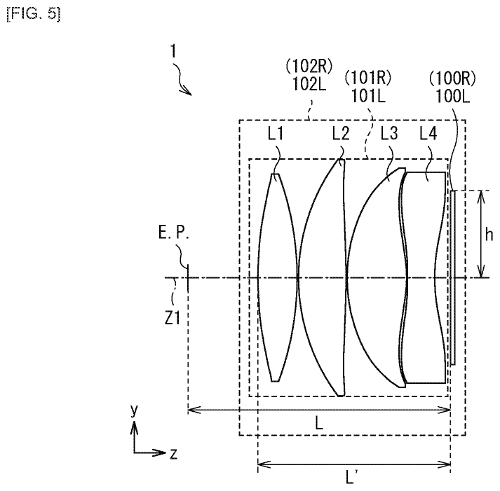

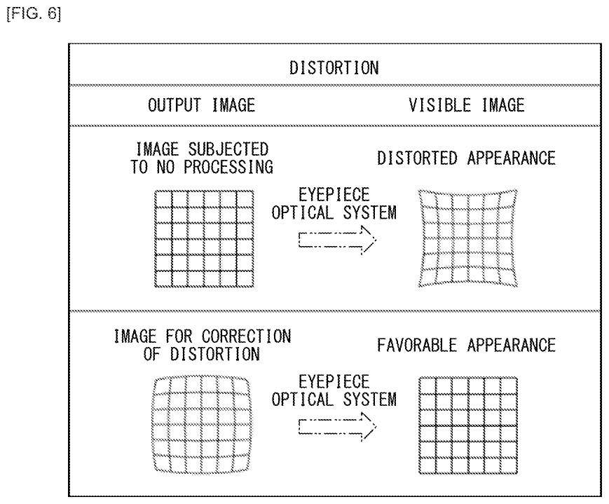

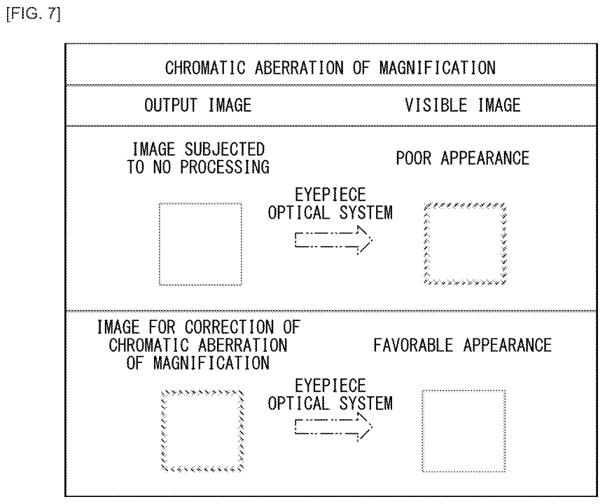

FIG. 6 illustrates a correspondence relationship between an output image to the image display device 100 and an image actually visible through the eyepiece optical system 101 having distortion. FIG. 7 illustrates a correspondence relationship between an output image to the image display device 100 and an image actually visible through the eyepiece optical system 101 having chromatic aberration of magnification.

As illustrated in FIGS. 6 and 7, in a case where an image having been subjected to no correction processing is outputted to the image display device 100, an image actually visible through the eyepiece optical system 101 is distorted and has poor appearance due to distortion and chromatic aberration of magnification generated in the eyepiece optical system 101. In contrast, in a case where respective correction images corresponding to the distortion and the chromatic aberration of magnification generated in the eyepiece optical system 101 are outputted to the image display device 100, both aberrations are canceled out, resulting in a favorable appearance.

### (Method of Correction of Distortion)

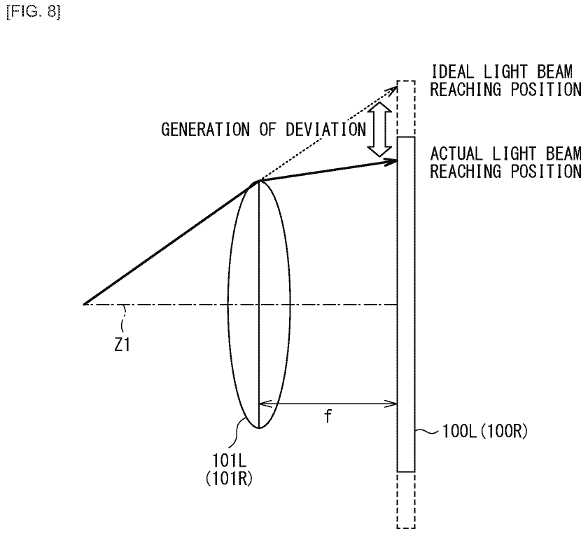

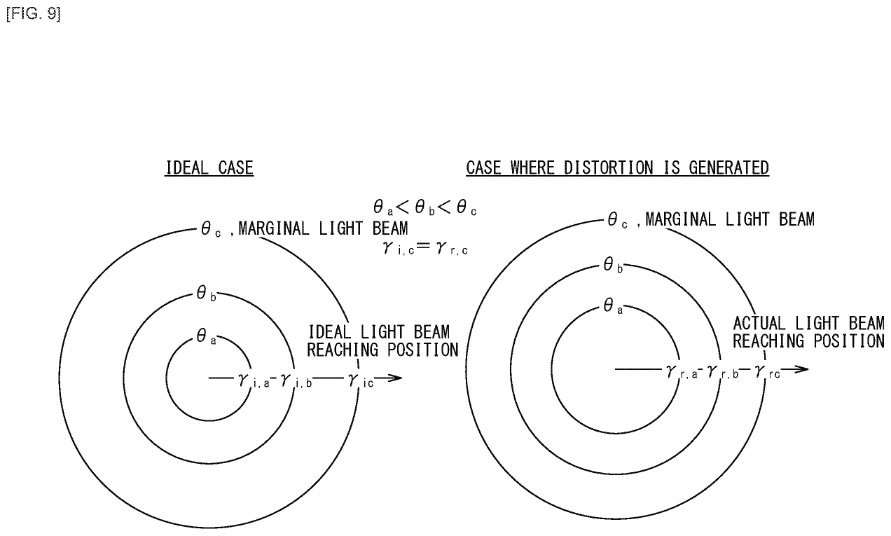

FIG. 8 illustrates an ideal light beam reaching position in the eyepiece optical system of a focal length f and a light beam reaching position (an actual light beam reaching position) distorted by generation of distortion. FIG. 9 schematically illustrates an ideal light beam reaching position and an actual light beam reaching position in a case where marginal light beams are aligned and an amount of deviation between the ideal light beam reaching position and the actual light beam reaching position. In FIG. 9, an ideal light beam reaching position of an angle θa is set as r_{i,a}; an ideal light beam reaching position of an angle θb is set as r_{i,b}; and an ideal light beam reaching position of an angle θc is set as r_{i,c}. In addition, an actual light beam reaching position of the angle θa in a case where the distortion is generated is set as r_{r,a}; an actual light beam reaching position of the angle θb in the case where the distortion is generated is set as r_{r,b}; and an actual light beam reaching position of the angle θc in the case where the distortion is generated is set as r_{r,c}. It is assumed here that θa<θb<θc holds true and that the marginal light beam is a light beam of the angle θc. In a case where the ideal light beam reaching position r_{i,c} and the actual light beam reaching position r_{r,c} of the marginal light beam are aligned (r_{i,c}=r_{r,c}), an amount of deviation between the light beam reaching positions of the angle θa is r_{r,a}−r_{i,a}, and an amount of deviation between the light beam reaching positions of the angle θb is r_{r,b}−r_{i,b}.

As illustrated in FIG. 8, a deviation is generated between the ideal light beam reaching position and the actual light beam reaching position at each angle. Description is given below of a method for eliminating the deviation and canceling out the generated distortion. First, as illustrated in FIG. 9, the ideal light beam reaching position r_{i,c} and the actual light beam reaching position r_{r,c} of the marginal light beam (light beam passing an outermost of the eyepiece optical system 101) are aligned. Next, an amount of deviation of the light beam reaching position at each of the angles is determined, and each determined amount of the deviation is reflected in the output image to the image display device 100. The above-described procedure enables formation of an image for correction of the distortion.

### (Method of Correction of Chromatic Aberration of Magnification)

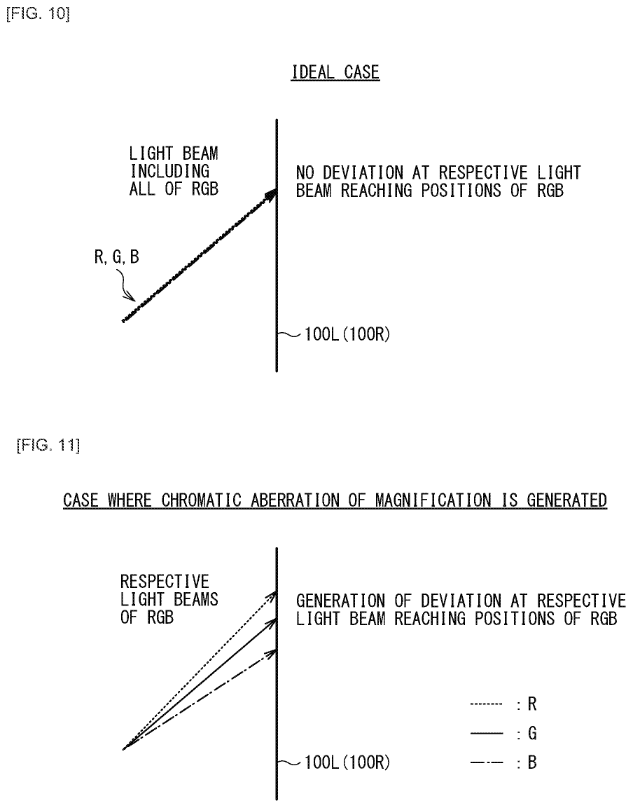

FIG. 10 illustrates ideal light beam reaching positions of light beams of respective colors outputted by the image display device 100 having a three-color (RGB) light source. FIG. 11 illustrates light beam reaching positions (actual light beam reaching positions) of respective colors varied due to generation of chromatic aberration of magnification.

In a case where there is chromatic aberration of magnification, as illustrated in FIG. 11, a deviation is generated in each of light beam reaching positions of RGB. In order to eliminate the deviation, a light beam reaching position for each of the colors at each angle is determined, and each determined light beam reaching position is reflected in an output image to the image display device 100, thereby enabling formation of an image for correction of chromatic aberration of magnification.

### (Limit of Correction of Chromatic Aberration of Magnification)

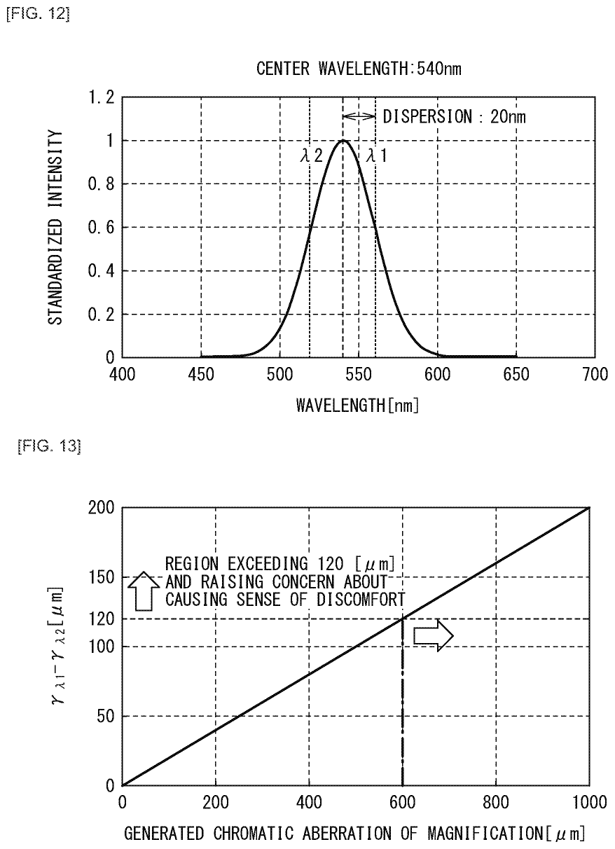

FIG. 12 illustrates a green spectrum of a typical image display device 100. As illustrated in FIG. 12, the green spectrum of the typical image display device 100 has a center wavelength of 540 nm and a dispersion of 20 nm, for example. Here, a short-side wavelength (520 nm) with −20 nm relative to the center wavelength of 540 nm is set as λ2, and a long-side wavelength (560 nm) with +20 nm relative to the center wavelength 540 nm is set as λ1.

FIG. 13 illustrates a correlation between chromatic aberration of magnification (an amount of deviation between a center wavelength of a red color and a center wavelength of a blue color) generated in the eyepiece optical system 101 and an amount of deviation (rλ₁−rλ₂) between light beam reaching positions rλ₁ and rλ₂ of the long-side wavelength λ1 (560 nm) of a green color and the short-side wavelength λ2 (520 nm) of the green color in a case where only the green color is emitted.

As illustrated in FIG. 13, when the chromatic aberration of magnification generated in the eyepiece optical system 101 exceeds 600 μm, the amount of deviation (rλ₁−rλ₂) between the light beam reaching positions of the long-side wavelength λ1 of the green color and the short-side wavelength λ2 of the green color exceeds 120 μm. Thus, it is presumed that an image is blurred, causing a sense of discomfort in the appearance even in a case of observation at a single wavelength. This leads to an acceptable amount of chromatic aberration of magnification of 600 μm.

### 2. Configuration Example and Workings and Effects of Eyepiece Optical System (Eyepiece)

Next, description is given of first and second configuration examples of the eyepiece that configures the left eyepiece optical system 101L and the right eyepiece optical system 101R in the display apparatus 1.

### First Configuration Example

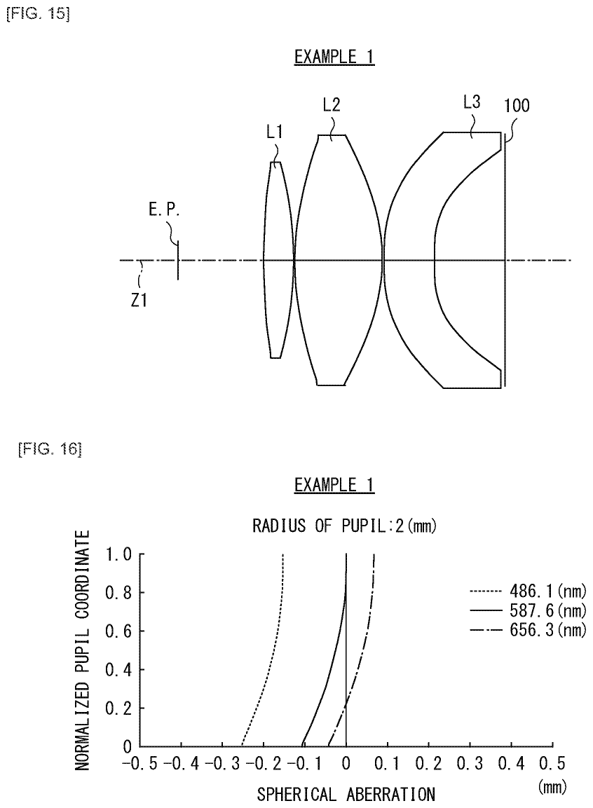

The configuration of an eyepiece according to the first configuration example corresponds to configurations of eyepieces (FIG. 15, etc.) according to Examples 1 to 9 described later. Each of the left eyepiece optical system 101L and the right eyepiece optical system 101R may be configured by an eyepiece of a three-group three-lens configuration in which a first lens L1, a second lens L2, and a third lens L3 are arranged as the plurality of single lenses in order from side of the eye point E.P. toward image side (side of the left-eye image display device 100L or side of the right-eye image display device 100R), as in the eyepieces (FIG. 15, etc.) according to Examples 1 to 9 described later.

In the above-described eyepiece (eyepiece according to the first configuration example) of the three-group three-lens configuration, the first lens L1 is preferably a spherical lens having a positive refractive power including a material of a refractive index of 1.439 or more with respect to a d-line. In addition, a lens surface of the first lens L1 on the side of the eye point E.P. preferably has a convex shape or a planar shape. Causing the first lens L1 to have a positive refractive power and the lens surface on the side of the eye point E.P. to have a convex shape or a planar shape makes it possible to suppress the maximal height of a marginal light beam. This allows for prospects of a reduction in capacitance of the optical system of each of the left eyepiece optical system 101L and the right eyepiece optical system 101R as well as a reduction in weight. In addition, using a spherical lens as the first lens L1 makes it possible to suppress manufacturing costs as compared with the case of using an aspherical lens.

In the eyepiece according to the first configuration example, the maximum amount of generation of the chromatic aberration of magnification is preferably 600 μm or less. When the maximum amount of generation of the chromatic aberration of magnification exceeds 600 μm, it becomes difficult to obtain a favorable image-forming capability. In addition, as illustrated in FIG. 13 mentioned above, in a case where the amount of generation of the chromatic aberration of magnification exceeds 600 μm, even an output of a correction image to the image display device 100 causes a sense of discomfort in the appearance.

In addition, in the eyepiece according to the first configuration example, at least one of the second lens L2 or the third lens L3 is preferably an aspherical lens. Using the aspherical lens makes it possible to favorably correct aberration to be generated.

In addition, the eyepiece according to the first configuration example preferably satisfies the following conditional expression (1A):

0.450<f/L′<0.800 (1A)

where

f denotes an effective focal length, and

L′ denotes a distance from a lens surface on side closest to the eye point E.P. in the plurality of single lenses (first to third lenses L1 to L3) to an image (a display surface of the image display device 100).

Satisfying the conditional expression (1A) makes it possible to obtain favorable image-forming characteristics, while achieving a reduction in size of the optical system. When exceeding the upper limit of the conditional expression (1A), it becomes difficult to ensure a sufficient total length of the optical system with respect to the effective focal length f, thus causing a concern about possible deterioration of resolution, field curvature, and distortion of a peripheral part when attempting to achieve an optical system having a predetermined image magnification. When falling below the lower limit of the conditional expression (1A), the total length of the optical system becomes too long for the effective focal length f, thus increasing a volume of the optical system when attempting to achieve an optical system having a predetermined image magnification. This causes a concern about possible prevention of a reduction in size of the entire display apparatus 1.

In addition, the eyepiece according to the first configuration example preferably satisfies the following conditional expression (2A):

0.400<t′/L′ (2A)

where

t′ denotes a summation of respective center thicknesses of the plurality of single lenses (first to third lenses L1 to L3), and

L′ denotes a distance from a lens surface on side closest to the eye point E.P. in the plurality of single lenses (first to third lenses L1 to L3) to an image (a display surface of the image display device 100).

In a head-mounted display having a high viewing angle, a pupil position shifts when observing a peripheral region of an image (hereinafter, referred to as “eye shift”). Satisfying the conditional expression (2A) makes it possible to ensure a sufficient lens thickness and to achieve robust characteristics against the eye shift. When falling below the lower limit of the conditional expression (2A), it becomes difficult to ensure a sufficient lens thickness, thus leading to a concern that the robustness against the eye shift may be lost.

### Second Configuration Example

A configuration of an eyepiece according to the second configuration example corresponds to configurations of eyepieces (FIG. 51, etc.) according to Examples 10 to 18 described later. Each of the left eyepiece optical system 101L and the right eyepiece optical system 101R may be configured by an eyepiece of a four-group four-lens configuration in which the first lens L1, the second lens L2, the third lens L3, and a fourth lens L3 are arranged as a plurality of single lenses in order from the side of the eye point E.P. toward the image side (side of the left-eye image display device 100L or side of the right-eye image display device 100R), as in the eyepieces (FIG. 51, etc.) according to Examples 10 to 18 described later.

In the above-described eyepiece (eyepiece according to the second configuration example) of the four-group four-lens configuration, the first lens L1 is preferably a spherical lens having a positive refractive power including a material of a refractive index of 1.439 or more with respect to a d-line. In addition, the lens surface of the first lens L1 on the side of the eye point E.P. preferably has a convex shape or a planar shape. Causing the first lens L1 to have a positive refractive power and the lens surface on the side of the eye point E.P. to have a convex shape or a planar shape makes it possible to suppress the maximal height of a marginal light beam. This allows for prospects of a reduction in capacitance of the optical system of each of the left eyepiece optical system 101L and the right eyepiece optical system 101R as well as a reduction in weight. In addition, using a spherical lens as the first lens L1 makes it possible to suppress manufacturing costs as compared with the case of using an aspherical lens.

In the eyepiece according to the second configuration example, the maximum amount of generation of the chromatic aberration of magnification is preferably 600 μm or less. When the maximum amount of generation of the chromatic aberration of magnification exceeds 600 μm, it becomes difficult to obtain a favorable image-forming capability. In addition, as illustrated in FIG. 13 mentioned above, in a case where the amount of generation of the chromatic aberration of magnification exceeds 600 μm, even an output of a correction image to the image display device 100 causes a sense of discomfort in the appearance.

In addition, in the eyepiece according to the second configuration example, at least one of the second lens L2, the third lens L3, or the fourth lens L4 is preferably an aspherical lens. Using the aspherical lens makes it possible to favorably correct aberration to be generated.

In addition, the eyepiece according to the second configuration example preferably satisfies the following conditional expression (1B):

0.450<f/L′<0.700 (1B)

where

f denotes an effective focal length, and

L′ denotes a distance from a lens surface on side closest to the eye point E.P. in the plurality of single lenses (first to fourth lenses L1 to L4) to an image (a display surface of the image display device 100).

Satisfying the conditional expression (1B) makes it possible to obtain favorable image-forming characteristics, while achieving a reduction in size of the optical system. When exceeding the upper limit of the conditional expression (1B), it becomes difficult to ensure a sufficient total length of the optical system with respect to the effective focal length f, thus causing a concern about possible deterioration of resolution, field curvature, and distortion of a peripheral part when attempting to achieve an optical system having a predetermined image magnification. When falling below the lower limit of the conditional expression (1B), the total length of the optical system becomes too long for the effective focal length f, thus increasing a volume of the optical system when attempting to achieve an optical system having a predetermined image magnification. This causes a concern about possible prevention of a reduction in size of the entire display apparatus 1.

In addition, the eyepiece according to the second configuration example preferably satisfies the following conditional expression (2B):

0.550<t′/L′ (2B)

where

t′ denotes a summation of respective center thicknesses of the plurality of single lenses (first to fourth lenses L1 to L4), and

L′ denotes a distance from a lens surface on side closest to the eye point E.P. in the plurality of single lenses (first to fourth lenses L1 to L4) to an image (a display surface of the image display device 100).

Satisfying the conditional expression (2B) makes it possible to ensure a sufficient lens thickness and to achieve robust characteristics against the eye shift. When falling below the lower limit of the conditional expression (2B), it becomes difficult to ensure a sufficient lens thickness, thus leading to a concern that the robustness against the eye shift may be lost.

### Effects of Invention

According to the display apparatus of an embodiment of the present disclosure, the configuration of the plurality of single lenses is optimized that configure the left eyepiece optical system 101L and the right eyepiece optical system 101R in a manner to include an aspherical lens including a resin material, and a display image for correction of distortion and chromatic aberration of magnification generated in the left eyepiece optical system 101L and the right eyepiece optical system 101R is displayed. This makes it possible to provide high-definition beauty of an image while achieving a lighter weight and a wider angle of view.

In particular, each of the left eyepiece optical system 101L and the right eyepiece optical system 101R is configured by a plurality of single lenses including an aspherical lens that includes a resin material to optimize the configuration of each lens, thereby achieving a lighter weight. In addition, the use of the resin material makes it possible to suppress material costs and manufacturing costs.

Applying the display apparatus according to an embodiment to a head-mounted display makes it possible to provide high-definition beauty of an image at a high viewing angle. In a head-mounted display having a high viewing angle, a pupil position shifts (eye shift) when observing a peripheral region of an image. At this time, it is difficult to secure desired optical characteristics for an amount of the eye shift assumed in the head-mounted display. According to the display apparatus of an embodiment, configuring the left eyepiece optical system 101L and the right eyepiece optical system 101R as described above makes it possible to achieve an optical system that is robust against the eye shift.

It is to be noted that the effects described herein are merely illustrative and non-limiting, and may have other effects.

### 3. Example of Application to Head-Mounted Display

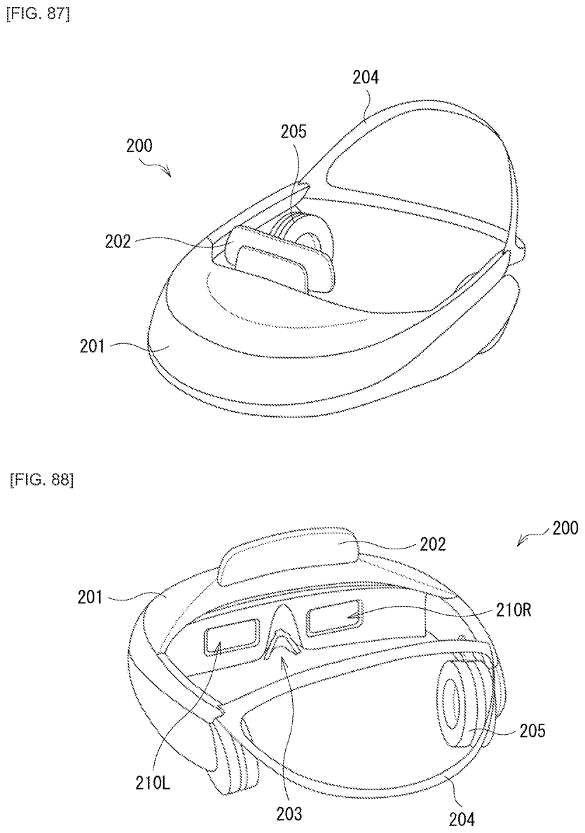

FIGS. 87 and 88 illustrate a configuration example of a head-mounted display 200 to which the display apparatus 1 according to an embodiment of the present disclosure is applied. The head-mounted display 200 includes a body 201, a forehead rest 202, a nose rest 203, a headband 204, and headphones 205. The forehead rest 202 is provided at an upper-middle part of the body 201. The nose rest 203 is provided at a lower-middle part of the body 201.

When a user wears the head-mounted display 200 on the head, the forehead rest 202 abuts the forehead of the user, and the nose rest 203 abuts the nose. Further, the headband 204 abuts the rear of the head. As a result, the head-mounted display 200 distributes a load of the apparatus over the entire head. This makes it possible for the user to wear the head-mounted display 200 with a less burden on the user.

The headphones 205 are provided for the left ear and the right ear. This makes it possible to provide sounds to the left ear and the right ear independently.

The body 201 is provided with a circuit board, an optical system, etc. that are built in the body 201 and are adapted to display an image. As illustrated in FIG. 88, a left-eye display part 210L and a right-eye display part 210R are provided in the body 201. This makes it possible to provide images to the left eye and the right eye independently. The left-eye display part 210L is provided with a left eyepiece display unit including an image display device for the left eye and an eyepiece optical system for the left eye that magnifies an image displayed on the image display device for the left eye. The right-eye display part 210R is provided with a right eyepiece display unit including an image display device for the right eye and an eyepiece optical system for the right eye that magnifies an image displayed on the image display device for the right eye. The left eyepiece display unit 102L and the right eyepiece display unit 102R in the display apparatus 1 according to an embodiment of the present disclosure are applicable as the left eyepiece display unit configuring the left-eye display part 210L and the right eyepiece display unit configuring the right-eye display part 210R.

It is to be noted that image data is supplied to the image display device from an unillustrated image reproducing apparatus. It is also possible to perform three-dimensional display by supplying three-dimensional image data from the image reproducing apparatus and displaying images having parallaxes with respect to each other by means of the left-eye display part 210L and the right-eye display part 210R.

### EXAMPLES

### Overview of Examples

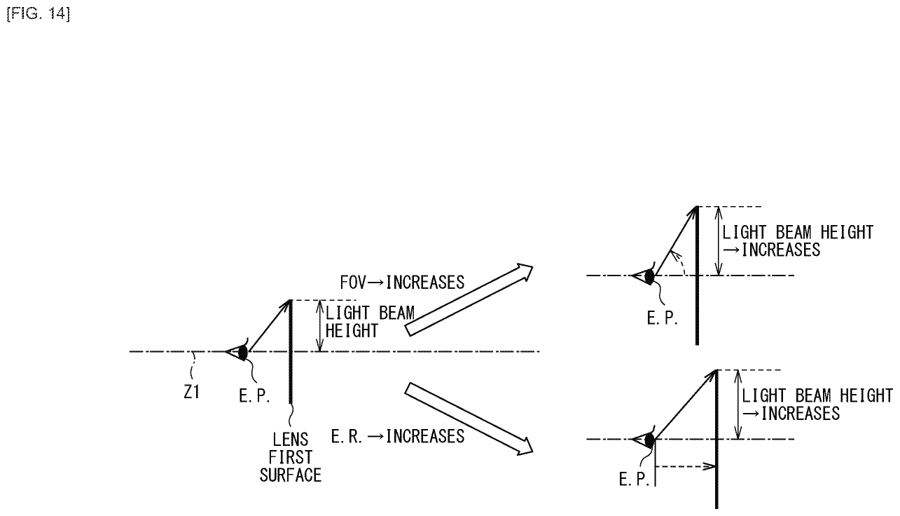

FIG. 14 schematically illustrates a relationship between magnitude of a field angle of view (FOV) as well as magnitude of an eye relief E.R. and a height of a light beam (marginal light beam) passing an outermost of a first surface of an eyepiece.

As illustrated in FIG. 14, increasing the field angle of view and the eye relief E.R. causes the height of the marginal light beam at the first surface of the eyepiece to increase. In a case of considering that the marginal light beam is caused to form an image on an equally-sized image display device 100, the light beam needs to be bent greater, as the height of the light beam increases. Accordingly, the amount of generation of aberration increases, thus causing the imaging-forming capability to be lowered. In this manner, the magnitude of each of the field angle of view and the eye relief E.R. is in a trade-off relationship with the imaging-forming capability.

In consideration of such characteristics, the following examples illustrate design examples of specifications in which the magnitudes of the field angle of view and the eye relief E.R. are changed as illustrated in Tables 1 and 2. Here, Examples 1 to 9 correspond to the eyepiece (eyepiece of three-group three-lens configuration) of the foregoing first configuration example. Examples 10 to 18 correspond to the eyepiece (eyepiece of four-group four-lens configuration) of the foregoing second configuration example. As illustrated in Tables 1 and 2, in each of the eyepiece of the three-group three-lens configuration and the eyepiece of the four-group four-lens configuration, the lens surface of the first lens L1 on the side of the eye point E.P. exhibits examples of a convex shape and examples of a planar shape.

TABLE 1

| | Example | Example | Example | Example | Example |
|---|---|---|---|---|---|
| | 1 | 2 | 3 | 4 | 5 |
| Lens | 3-Group | 3-Group | 3-Group | 3-Group | 3-Group |
| Configuration | 3-Lens | 3-Lens | 3-Lens | 3-Lens | 3-Lens |
| FOV [degree] | 90 | 90 | 90 | 100 | 100 |
| Eye Relief E.R. | 11 | 13 | 15 | 11 | 13 |
| [mm] | | | | | |
| Shape of L1 on | Convex | Convex | Convex | Convex | Convex |
| E.P. Side | | | | | |

| | Example | Example | Example | Example |
|---|---|---|---|---|
| | 6 | 7 | 8 | 9 |
| Lens | 3-Group | 3-Group | 3-Group | 3-Group |
| Configuration | 3-Lens | 3-Lens | 3-Lens | 3-Lens |
| FOV [degree] | 100 | 110 | 110 | 90 |
| Eye Relief E.R. | 15 | 11 | 13 | 11 |
| [mm] | | | | |
| Shape of L1 on | Convex | Convex | Convex | Flat |
| E.P. Side | | | | |

TABLE 2

| | Example | Example | Example | Example | Example |
|---|---|---|---|---|---|
| | 10 | 11 | 12 | 13 | 14 |
| Lens | 4-Group | 4-Group | 4-Group | 4-Group | 4-Group |
| Configuration | 4-Lens | 4-Lens | 4-Lens | 4-Lens | 4-Lens |
| FOV [degree] | 90 | 90 | 90 | 100 | 100 |
| Eye Relief E.R. | 11 | 13 | 15 | 11 | 13 |
| [mm] | | | | | |
| Shape of L1 on | Convex | Convex | Convex | Convex | Convex |
| E.P. Side | | | | | |

| | Example | Example | Example | Example |
|---|---|---|---|---|
| | 15 | 16 | 17 | 18 |
| Lens | 4-Group | 4-Group | 4-Group | 4-Group |
| Configuration | 4-Lens | 4-Lens | 4-Lens | 4-Lens |
| FOV [degree] | 100 | 110 | 110 | 90 |
| Eye Relief E.R. | 15 | 11 | 13 | 11 |
| [mm] | | | | |
| Shape of L1 on | Convex | Convex | Convex | Flat |
| E.P. Side | | | | |

### 4. Numerical Examples of Eyepiece Optical System (Eyepiece)

Specific lens data of eyepieces according to respective examples exhibited in Tables 1 and 2 are given below. The eyepiece according to each of the examples corresponds to each of the left eyepiece optical system 101L and the right eyepiece optical system 101R, and is applied to each of the left eyepiece display unit 102L and the right eyepiece display unit 102R. In the eyepiece according to each of the examples, the left-eye image display device 100L or the right-eye image display device 100R is referred to as the image display device 100 without distinction between the left and the right.

It is to be noted that meanings, etc. of symbols used in the following tables and descriptions are as follows. “Si” denotes the number of i-th surface, which is numbered to sequentially increase toward the image side, with the eye point E.P. being numbered as the first. “Ri” denotes a paraxial curvature radius (mm) of the i-th surface. “Di” denotes an interval (mm) on an optical axis between the i-th surface and (i+1)-th surface. “Ndi” denotes a value of a refractive index at a d-line (a wavelength of 587.6 nm) of a material (medium) of an optical element having the i-th surface. “νdi” denotes a value of Abbe's number at the d-line of the material of the optical element having the i-th surface. A surface having a curvature radius of “∞” indicates a planar surface or a stop surface (an aperture stop STO (eye point E.P.)).

### (Expression of Aspherical Surface)

The eyepiece according to each of the examples includes an aspherical lens. An aspherical shape is defined by the following expression (1.1) of an aspherical surface. It is to be noted that, in each of the following tables exhibiting aspherical surfaces, “E-n” denotes an exponential expression with a base of 10, i.e., “minus n-th power of 10”. For example, “0.12345E-05” denotes “0.12345×(minus fifth power of 10)”.

$$Za ( s ) = \frac{\frac{1}{R} {s}^{2}}{1 + \sqrt{1 - ( 1 + k ) \frac{1}{{R}^{2}} {s}^{2}}} + A 3 {s}^{3} + A 4 {s}^{4} + A 5 {s}^{5} + A 6 {s}^{6} + … \qquad ( 1.1 )$$

In the expression,

Za (s) denotes a sag amount of an aspherical shape with reference to an optical axis of each lens element,

s denotes a distance from an optical axis of each lens element (tangential direction),

R denotes a curvature radius,

k denotes a conic constant, and

Ai denotes an aspherical coefficient of degree i.

### Example 1

Table 3 exhibits basic lens data of an eyepiece according to Example 1. In addition, Table 4 exhibits aspherical surface data.

TABLE 3
Example 1 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 84.490 | 3.744 | 1.439 | 94.7 |
| 3 | −49.971 | 0.200 | — | — |
| 4 | 27.357 | 11.154 | 1.533 | 56.0 |
| 5 | −28.918 | 0.200 | — | — |
| 6 | 57.125 | 6.427 | 1.533 | 56.0 |
| 7 | ∞ | 9.050 | — | — |
| 8 | ∞ | — | — | — |

TABLE 4
Example 1 Aspherical Surface Data

| Si | k | | | | |
|---|---|---|---|---|---|
| Surface | Conic | | | | |
| No. | Constant | A3 | A4 | A5 | A6 |
| 4 | −2.879 | −5.638E−04 | 1.865E−05 | 2.720E−07 | −5.251E−09 |
| 5 | −2.534 | −5.888E−04 | 2.371E−05 | 3.653E−07 | −1.405E−08 |
| 6 | 5.890 | 1.685E−03 | −1.793E−05 | −8.171E−07 | −1.437E−08 |
| 7 | 0.000 | 4.362E−03 | −5.167E−05 | −3.831E−06 | 6.799E−08 |

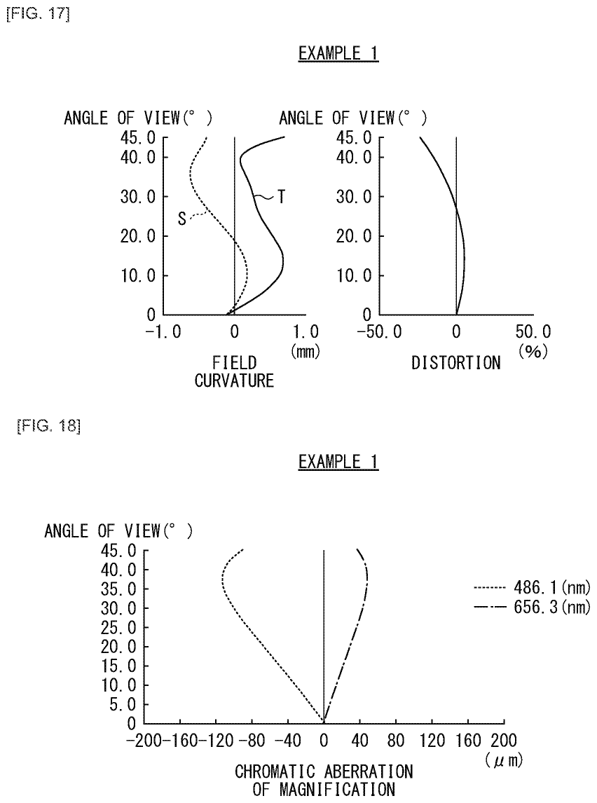

FIG. 15 illustrates a lens cross-section of the eyepiece according to Example 1. FIGS. 16 to 18 illustrate various aberrations of the eyepiece according to Example 1. Each aberration is obtained by tracing a light beam from the side of the eye point E.P. In particular, FIG. 16 illustrates spherical aberration. In particular, FIG. 17 illustrates astigmatism (field curvature) and distortion. FIG. 18 illustrates chromatic aberration of magnification. A spherical aberration diagram indicates values for a wavelength of 486.1 (nm), a wavelength of 587.6 (nm), and a wavelength of 656.3 (nm). An astigmatism diagram and a distortion diagram indicate a value for the wavelength of 587.6 (nm). In the astigmatism diagram, S denotes a value on a sagittal image plane, and T denotes a value on a tangential image plane. A diagram of chromatic aberration of magnification indicates values for the wavelength of 486.1 (nm) and the wavelength of 656.3 (nm), with the wavelength of 587.6 (nm) as a reference wavelength.

It is to be noted that each aberration diagram illustrates aberrations in a case where a light beam tracing angle is changed in a y-direction (see FIG. 5). The same holds true also for aberration diagrams in other examples below.

As can be appreciated from each of the aberration diagrams, it is obvious that Example 1 exhibits favorable optical performance.

### Example 2

Table 5 exhibits basic lens data of an eyepiece according to Example 2. In addition, Table 6 exhibits aspherical surface data.

TABLE 5
Example 2 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 121.781 | 6.544 | 1.755 | 52.3 |
| 3 | −39.004 | 0.200 | — | — |
| 4 | 35.091 | 9.936 | 1.533 | 56.0 |
| 5 | −152.029 | 0.200 | — | — |
| 6 | 29.513 | 8.468 | 1.533 | 56.0 |
| 7 | ∞ | 6.989 | — | — |
| 8 | ∞ | — | — | — |

TABLE 6
Example 2 Aspherical Surface Data

| Si | k | | | | |
|---|---|---|---|---|---|
| Surface | Conic | | | | |
| No. | Constant | A3 | A4 | A5 | A6 |
| 4 | −1.161 | 2.682E−04 | −1.582E−06 | −5.872E−08 | −5.750E−09 |
| 5 | 37.129 | −1.311E−04 | 1.773E−05 | −1.564E−07 | −4.426E−09 |
| 6 | 1.328 | −9.012E−04 | 2.712E−05 | 3.851E−06 | −1.793E−07 |
| 7 | 0.000 | 1.582E−03 | −1.013E−04 | 1.462E−05 | −4.022E−07 |

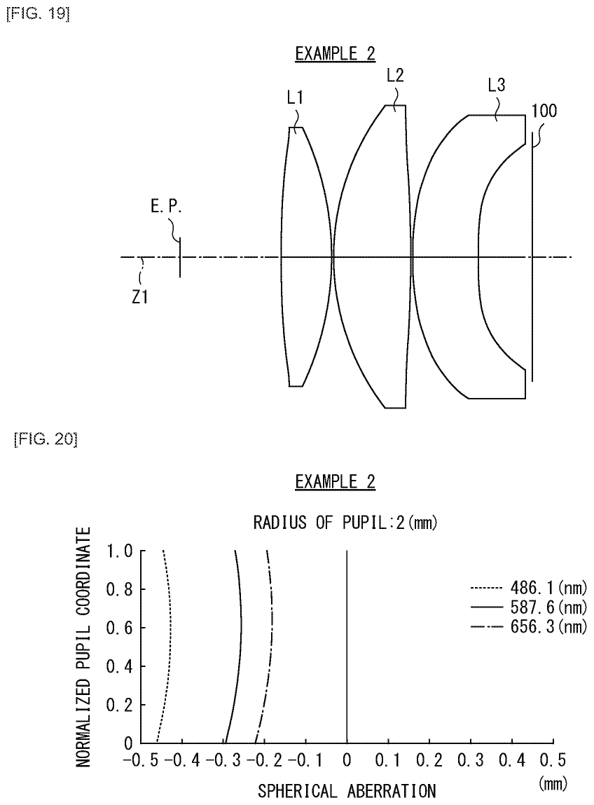

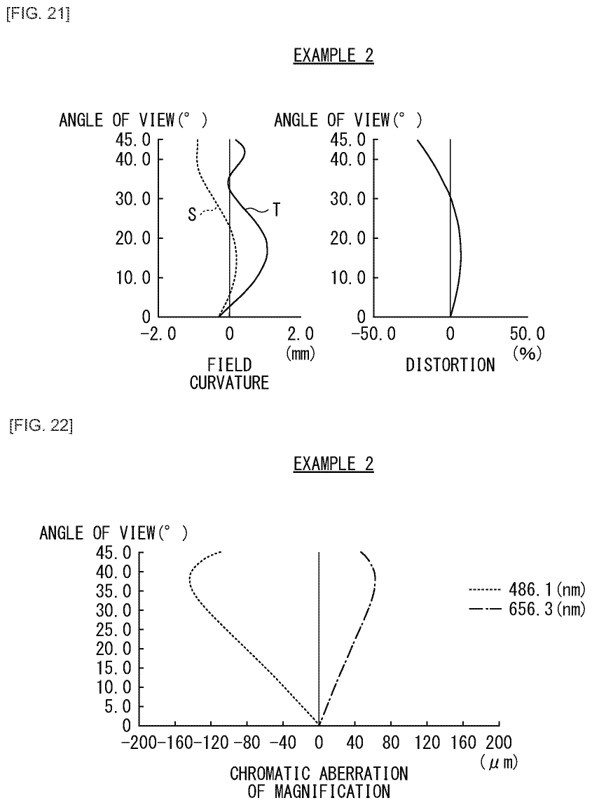

FIG. 19 illustrates a lens cross-section of the eyepiece according to Example 2. FIGS. 20 to 22 illustrate various aberrations of the eyepiece according to Example 2.

As can be appreciated from each of the aberration diagrams, it is obvious that the eyepiece according to Example 2 has favorable optical performance.

### Example 3

Table 7 exhibits basic lens data of an eyepiece according to Example 3. In addition, Table 8 exhibits aspherical surface data.

TABLE 7
Example 3 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 15.000 | — | — |
| 2 | 87.738 | 6.334 | 1.880 | 40.8 |
| 3 | −67.790 | 0.200 | — | — |
| 4 | 30.333 | 9.173 | 1.533 | 56.0 |
| 5 | 170.210 | 0.200 | — | — |
| 6 | 38.609 | 14.424 | 1.533 | 56.0 |
| 7 | 110.370 | 5.142 | — | — |
| 8 | ∞ | — | — | — |

TABLE 8
Example 3 Aspherical Surface Data

| Si | k | | | | |
|---|---|---|---|---|---|
| Surface | Conic | | | | |
| No. | Constant | A3 | A4 | A5 | A6 |
| 4 | −0.305 | −7.469E−06 | −7.682E−07 | −3.380E−08 | −1.521E−09 |
| 5 | 11.326 | −1.095E−06 | 1.716E−07 | 1.389E−09 | 4.850E−10 |
| 6 | 1.967 | −2.440E−05 | −5.851E−07 | 4.674E−08 | 5.046E−09 |
| 7 | 22.145 | −1.877E−05 | 2.587E−06 | 2.021E−07 | 1.142E−08 |

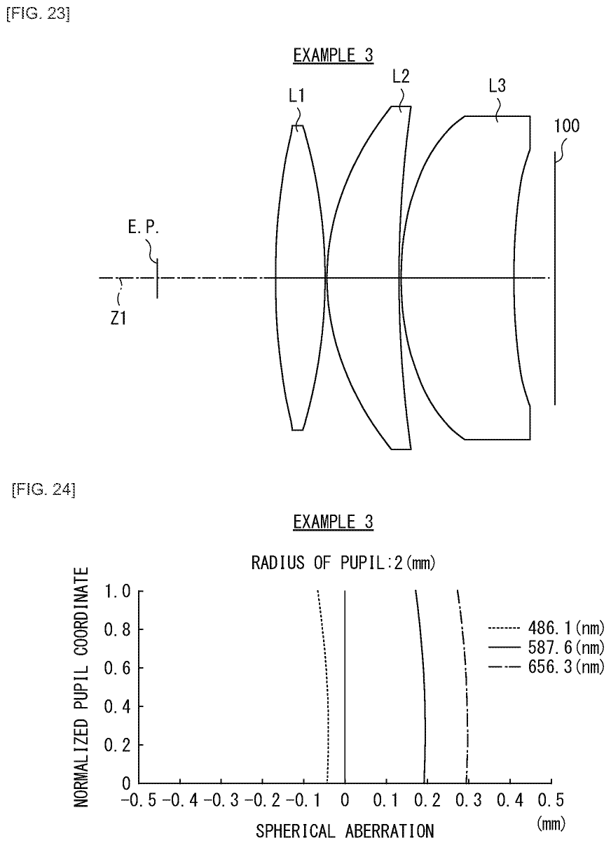

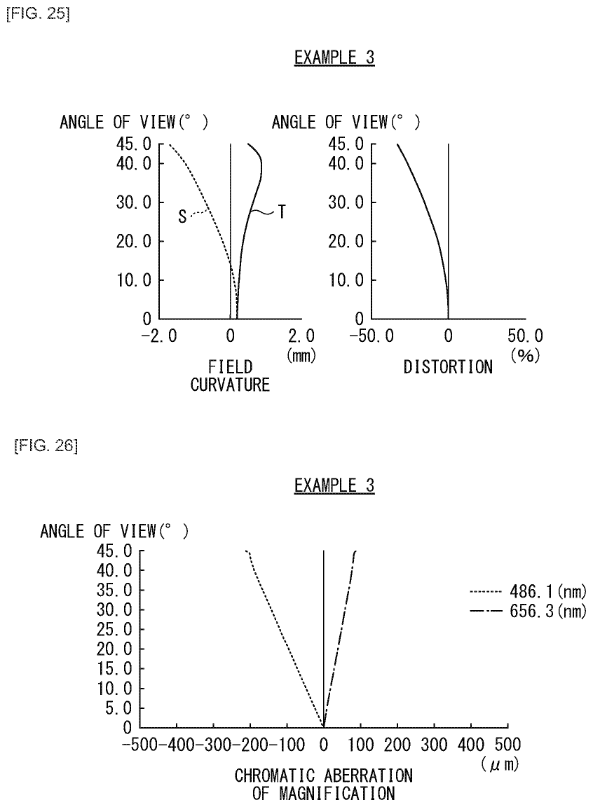

FIG. 23 illustrates a lens cross-section of the eyepiece according to Example 3. FIGS. 24 to 26 illustrate various aberrations of the eyepiece according to Example 3.

As can be appreciated from each of the aberration diagrams, it is obvious that the eyepiece according to Example 3 has favorable optical performance.

### Example 4

Table 9 exhibits basic lens data of an eyepiece according to Example 4. In addition, Table 10 exhibits aspherical surface data.

TABLE 9
Example 4 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 62.936 | 5.532 | 1.755 | 52.3 |
| 3 | −65.242 | 0.200 | — | — |
| 4 | 35.499 | 9.102 | 1.533 | 56.0 |
| 5 | −52.731 | 0.200 | — | — |
| 6 | 33.138 | 10.704 | 1.533 | 56.0 |
| 7 | 62.402 | 5.490 | — | — |
| 8 | ∞ | — | — | — |

TABLE 10
Example 4 Aspherical Surface Data

| Si | k | | | | |
|---|---|---|---|---|---|
| Surface | Conic | | | | |
| No. | Constant | A3 | A4 | A5 | A6 |
| 4 | −0.586 | 2.769E−05 | 1.058E−06 | −1.052E−10 | −1.066E−11 |
| 5 | −6.813 | 1.442E−05 | 5.118E−06 | 3.784E−11 | 1.766E−12 |
| 6 | 1.655 | −2.010E−04 | 8.409E−06 | 1.920E−07 | −2.390E−08 |
| 7 | 15.179 | 4.543E−04 | 1.261E−05 | −4.720E−07 | 6.838E−08 |

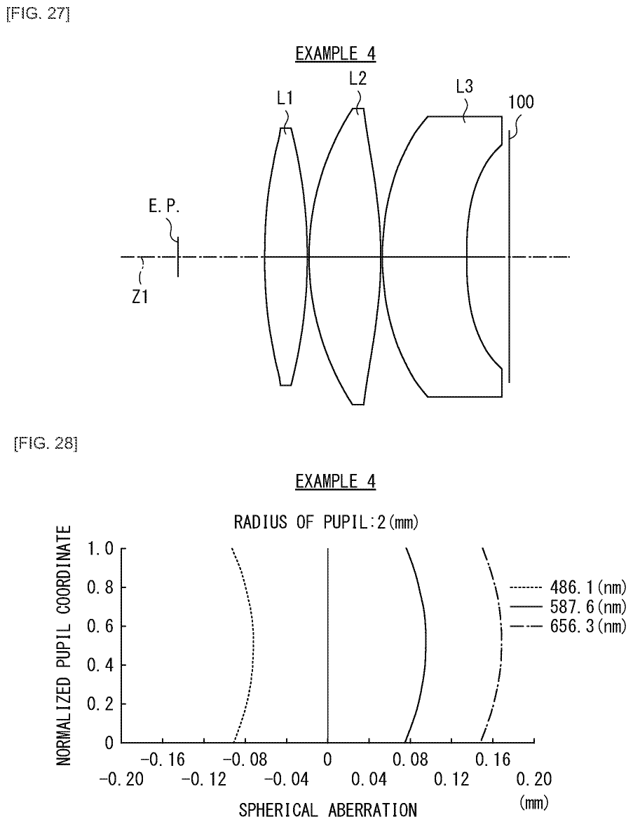

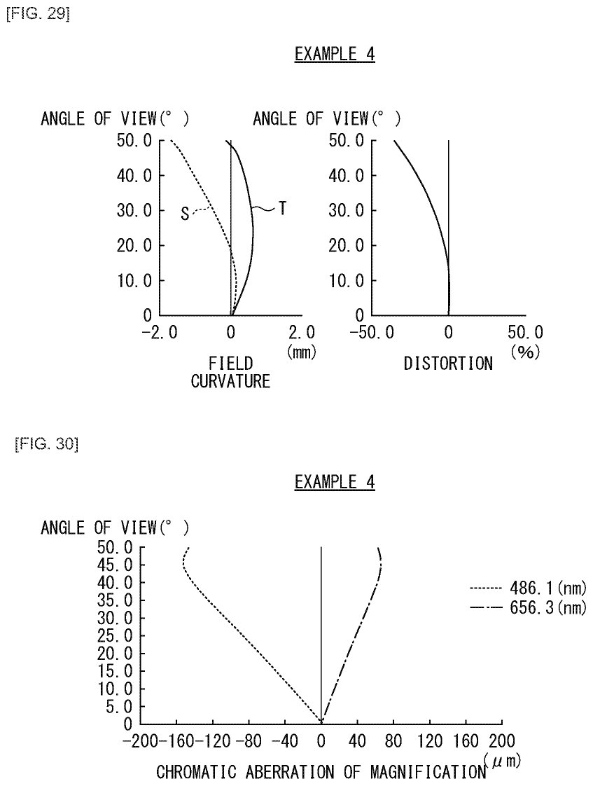

FIG. 27 illustrates a lens cross-section of the eyepiece according to Example 4. FIGS. 28 to 30 illustrate various aberrations of the eyepiece according to Example 4.

As can be appreciated from each of the aberration diagrams, it is obvious that the eyepiece according to Example 4 has favorable optical performance.

### Example 5

Table 11 exhibits basic lens data of an eyepiece according to Example 5. In addition, Table 12 exhibits aspherical surface data.

TABLE 11
Example 5 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 69.268 | 6.895 | 1.755 | 52.3 |
| 3 | −64.673 | 0.200 | — | — |
| 4 | 33.703 | 11.034 | 1.533 | 56.0 |
| 5 | −57.898 | 0.200 | — | — |
| 6 | 31.214 | 12.490 | 1.533 | 56.0 |
| 7 | 62.594 | 3.651 | — | — |
| 8 | ∞ | — | — | — |

TABLE 12
Example 5 Aspherical Surface Data

| Si | k | | | | |
|---|---|---|---|---|---|
| Surface | Conic | | | | |
| No. | Constant | A3 | A4 | A5 | A6 |
| 4 | −1.119 | 1.039E−05 | 8.404E−07 | 1.093E−08 | 8.112E−11 |
| 5 | −7.183 | 2.847E−06 | 6.066E−06 | 1.607E−09 | −9.683E−10 |
| 6 | 1.186 | −2.900E−04 | 6.489E−06 | 5.974E−08 | 3.892E−09 |
| 7 | −7.696 | −3.584E−05 | 4.636E−06 | 7.393E−08 | −1.112E−08 |

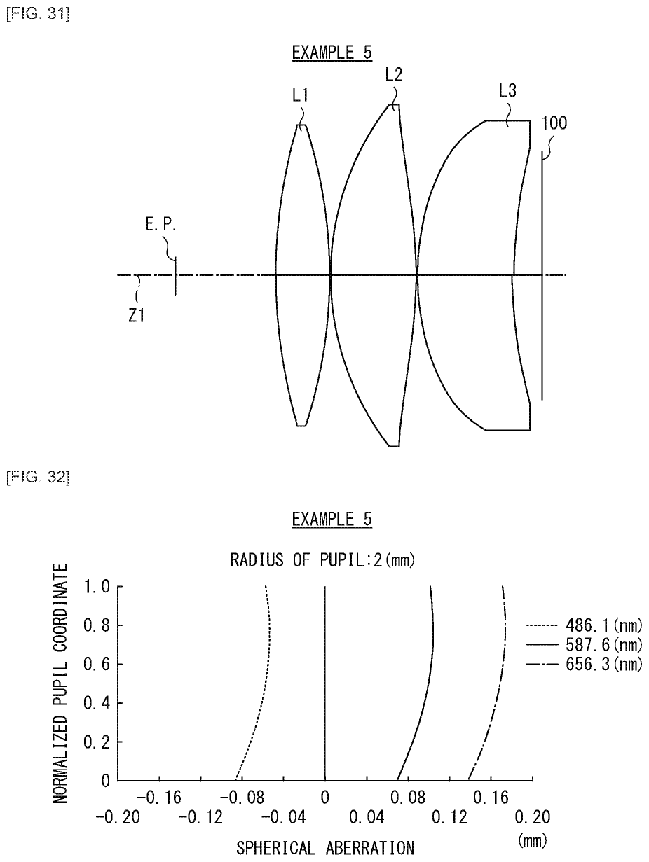

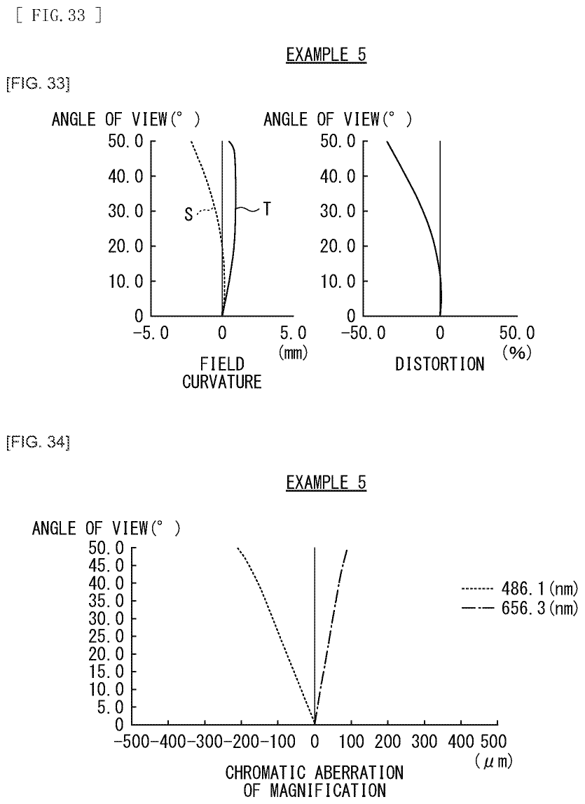

FIG. 31 illustrates a lens cross-section of the eyepiece according to Example 5. FIGS. 32 to 34 illustrate various aberrations of the eyepiece according to Example 5.

As can be appreciated from each of the aberration diagrams, it is obvious that the eyepiece according to Example 5 has favorable optical performance.

### Example 6

Table 13 exhibits basic lens data of an eyepiece according to Example 6. In addition, Table 14 exhibits aspherical surface data.

TABLE 13
Example 6 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 15.000 | — | — |
| 2 | 252.596 | 6.677 | 1.877 | 40.8 |
| 3 | −41.689 | 0.200 | — | — |
| 4 | 35.595 | 14.487 | 1.533 | 56.0 |
| 5 | −37.242 | 0.200 | — | — |
| 6 | 26.393 | 10.206 | 1.533 | 56.0 |
| 7 | 23.234 | 2.930 | — | — |
| 8 | ∞ | — | — | — |

TABLE 14
Example 6 Aspherical Surface Data

| Si | k | | | | |
|---|---|---|---|---|---|
| Surface | Conic | | | | |
| No. | Constant | A3 | A4 | A5 | A6 |
| 4 | −0.135 | −4.032E−05 | 1.842E−05 | −5.118E−09 | −2.595E−08 |
| 5 | −2.326 | 5.756E−05 | 1.532E−05 | 2.863E−07 | −2.710E−08 |
| 6 | −54.106 | 9.079E−04 | −1.560E−05 | −6.423E−06 | 3.317E−07 |
| 7 | −0.906 | −6.914E−04 | −1.534E−05 | −3.287E−09 | 1.215E−08 |

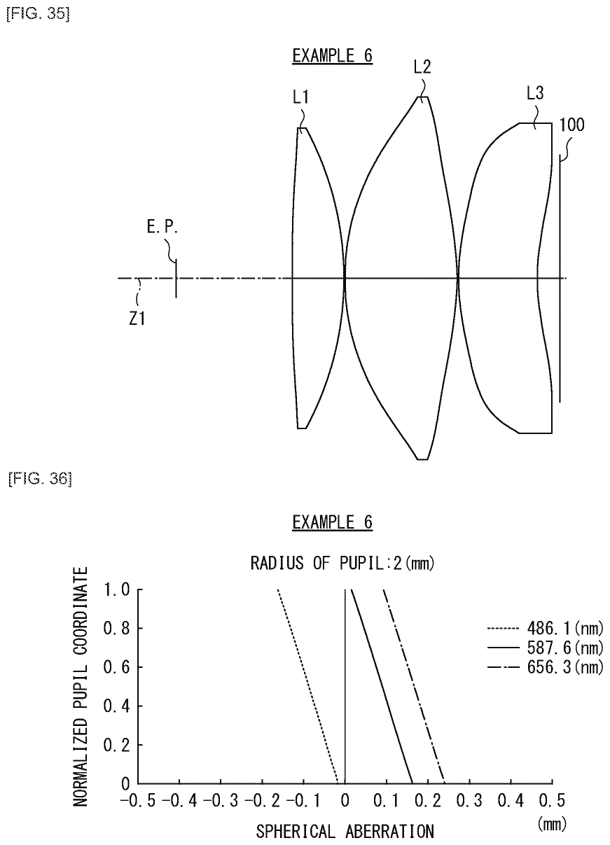

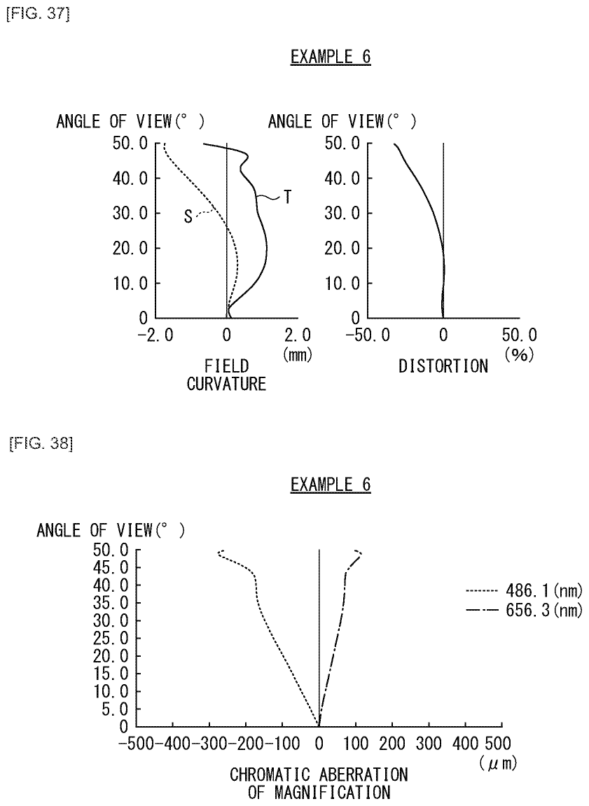

FIG. 35 illustrates a lens cross-section of the eyepiece according to Example 6. FIGS. 36 to 38 illustrate various aberrations of the eyepiece according to Example 6.

As can be appreciated from each of the aberration diagrams, it is obvious that the eyepiece according to Example 6 has favorable optical performance.

### Example 7

Table 15 exhibits basic lens data of an eyepiece according to Example 7. In addition, Table 16 exhibits aspherical surface data.

TABLE 15
Example 7 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 89.933 | 7.137 | 1.877 | 40.8 |
| 3 | −51.264 | 0.200 | — | — |
| 4 | 34.502 | 12.242 | 1.533 | 56.0 |
| 5 | −33.268 | 0.200 | — | — |
| 6 | 30.378 | 11.806 | 1.533 | 56.0 |
| 7 | 11.000 | 1.951 | — | — |
| 8 | ∞ | — | — | — |

TABLE 16
Example 7 Aspherical Surface Data

| Si | k | | | | |
|---|---|---|---|---|---|
| Surface | Conic | | | | |
| No. | Constant | A3 | A4 | A5 | A6 |
| 4 | −0.498 | −2.771E−04 | 2.867E−05 | 2.257E−07 | −4.168E−08 |
| 5 | −1.167 | 3.154E−04 | 1.215E−05 | 4.334E−07 | −3.004E−08 |
| 6 | 1.398 | −3.327E−05 | −5.277E−05 | −9.552E−07 | 1.403E−07 |
| 7 | −12.708 | −2.214E−03 | 1.406E−04 | −3.061E−06 | 2.347E−08 |

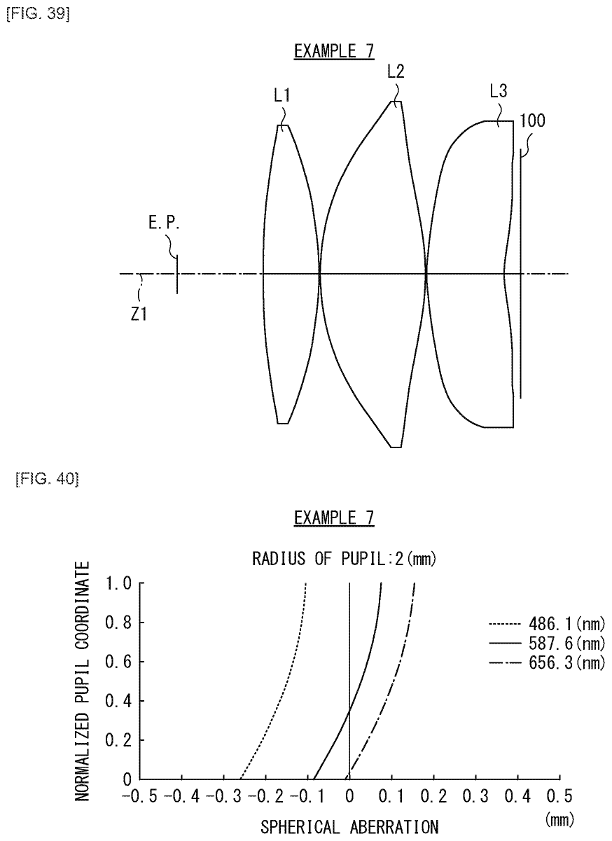

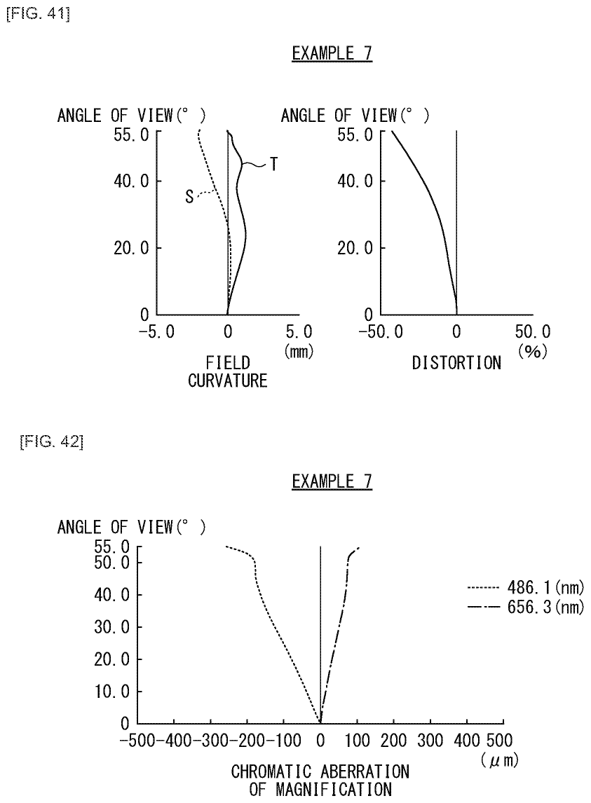

FIG. 39 illustrates a lens cross-section of the eyepiece according to Example 7. FIGS. 40 to 42 illustrate various aberrations of the eyepiece according to Example 7.

As can be appreciated from each of the aberration diagrams, it is obvious that the eyepiece according to Example 7 has favorable optical performance.

### Example 8

Table 17 exhibits basic lens data of an eyepiece according to Example 8. In addition, Table 18 exhibits aspherical surface data.

TABLE 17
Example 8 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 458.830 | 7.700 | 1.877 | 40.8 |
| 3 | −33.682 | 0.200 | — | — |
| 4 | 25.984 | 16.283 | 1.533 | 56.0 |
| 5 | −149.575 | 0.200 | — | — |
| 6 | 31.376 | 9.240 | 1.533 | 56.0 |
| 7 | ∞ | 1.259 | — | — |
| 8 | ∞ | — | — | — |

TABLE 18
Example 8 Aspherical Surface Data

| Si | k | | | | |
|---|---|---|---|---|---|
| Surface | Conic | | | | |
| No. | Constant | A3 | A4 | A5 | A6 |
| 4 | −0.679 | 8.749E−05 | 6.647E−06 | −1.428E−07 | −1.592E−08 |
| 5 | 25.470 | −2.472E−05 | −4.634E−07 | −3.605E−08 | −2.070E−09 |
| 6 | 1.618 | −3.033E−04 | 1.747E−05 | −6.606E−06 | 2.954E−07 |
| 7 | 0.000 | −2.453E−04 | 2.611E−05 | 7.832E−07 | −6.167E−08 |

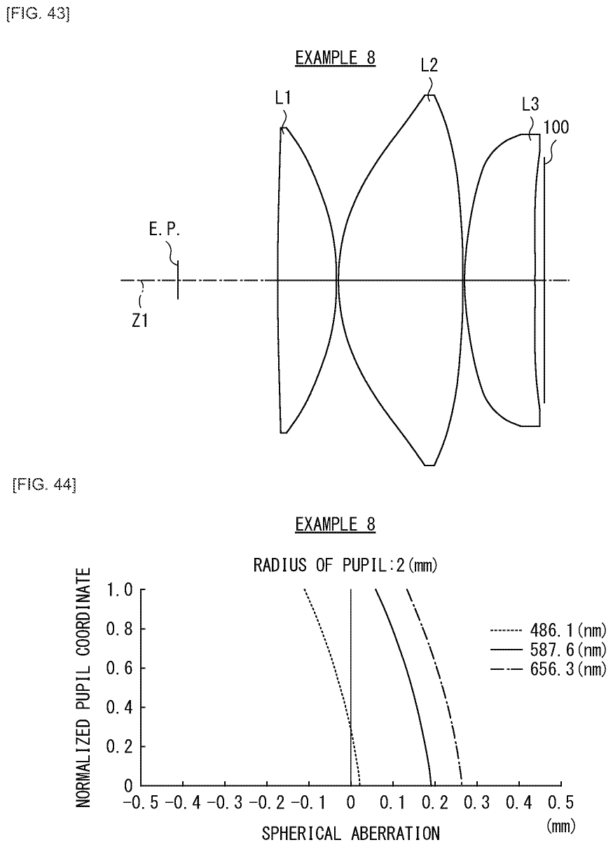

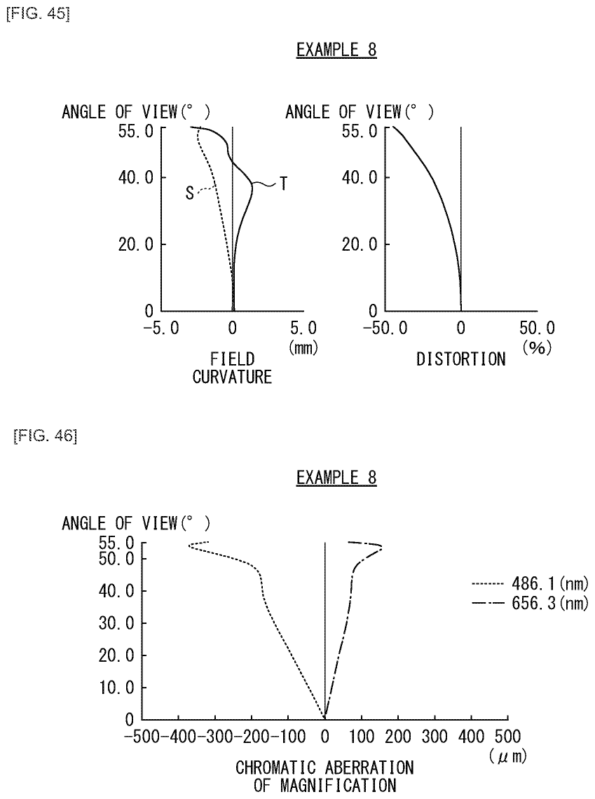

FIG. 43 illustrates a lens cross-section of the eyepiece according to Example 8. FIGS. 44 to 46 illustrate various aberrations of the eyepiece according to Example 8.

As can be appreciated from each of the aberration diagrams, it is obvious that the eyepiece according to Example 8 has favorable optical performance.

### Example 9

Table 19 exhibits basic lens data of an eyepiece according to Example 9. In addition, Table 20 exhibits aspherical surface data.

TABLE 19
Example 9 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | ∞ | 3.492 | 1.755 | 52.3 |
| 3 | −44.359 | 0.200 | — | — |
| 4 | 77.885 | 3.500 | 1.755 | 52.3 |
| 5 | −112.776 | 0.200 | — | — |
| 6 | 38.051 | 6.019 | 1.533 | 56.0 |
| 7 | ∞ | 15.004 | — | — |
| 8 | ∞ | — | — | — |

TABLE 20
Example 9 Aspherical Surface Data

| Si | k | | | | |
|---|---|---|---|---|---|
| Surface | Conic | | | | |
| No. | Constant | A3 | A4 | A5 | A6 |
| 6 | −176.012 | 1.373E−03 | −2.824E−05 | −6.946E−07 | 5.863E−08 |
| 7 | 0.000 | 6.868E−05 | 4.489E−05 | −2.301E−06 | 2.975E−08 |

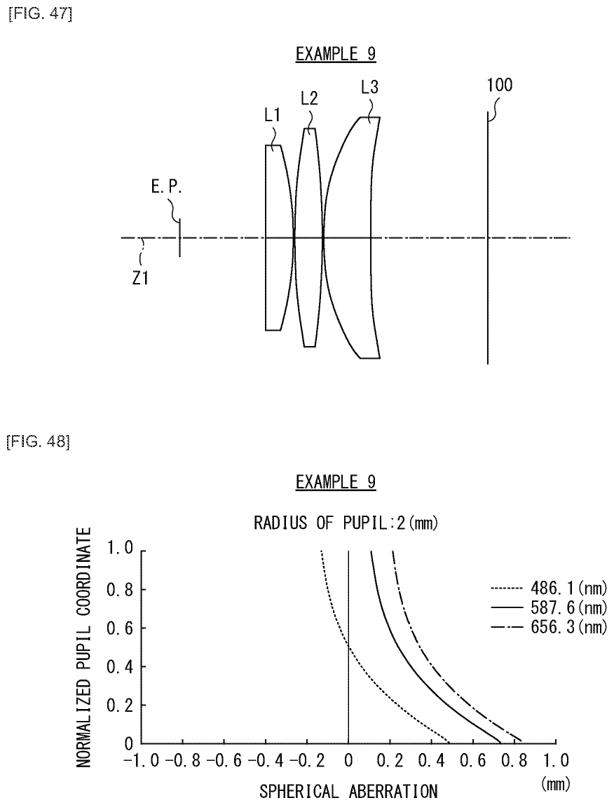

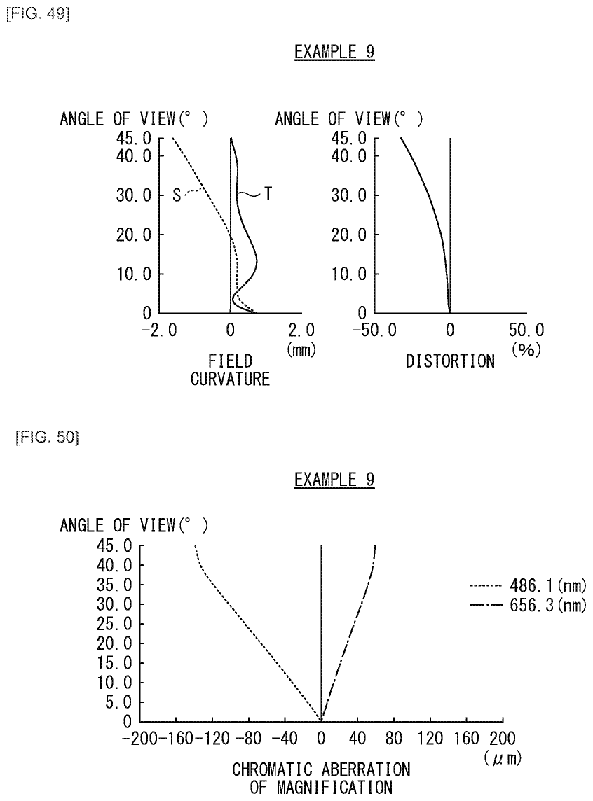

FIG. 47 illustrates a lens cross-section of the eyepiece according to Example 9. FIGS. 48 to 50 illustrate various aberrations of the eyepiece according to Example 9.

As can be appreciated from each of the aberration diagrams, it is obvious that the eyepiece according to Example 9 has favorable optical performance.

### Example 10

Table 21 exhibits basic lens data of an eyepiece according to Example 10. In addition, Table 22 exhibits aspherical surface data.

TABLE 21
Example 10 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 56.312 | 4.691 | 1.439 | 94.7 |
| 3 | −42.852 | 0.193 | — | — |
| 4 | 42.259 | 5.892 | 1.533 | 56.0 |
| 5 | −60.964 | 0.197 | — | — |
| 6 | 52.618 | 4.702 | 1.533 | 56.0 |
| 7 | 662.205 | 0.799 | — | — |
| 8 | 25.200 | 5.644 | 1.661 | 20.4 |
| 9 | 26.932 | 8.204 | — | — |
| 10 | ∞ | — | — | — |

TABLE 22
Example 10 Aspherical Surface Data

| Si | k | | | | |
|---|---|---|---|---|---|
| Surface | Conic | | | | |
| No. | Constant | A3 | A4 | A5 | A6 |
| 4 | −0.261 | −1.381E−04 | −1.525E−06 | 1.449E−08 | 4.496E−09 |
| 5 | 2.228 | −6.290E−05 | −2.371E−06 | 1.187E−07 | 8.406E−09 |
| 6 | 4.830 | 1.253E−04 | 2.297E−06 | −2.423E−07 | 1.299E−09 |
| 7 | 744.645 | −2.752E−05 | 4.026E−06 | 2.580E−07 | −4.571E−09 |
| 8 | 0.178 | 3.847E−04 | 7.246E−06 | −1.012E−06 | −1.080E−07 |
| 9 | −0.635 | 1.873E−03 | 1.011E−05 | −1.505E−06 | −1.518E−07 |

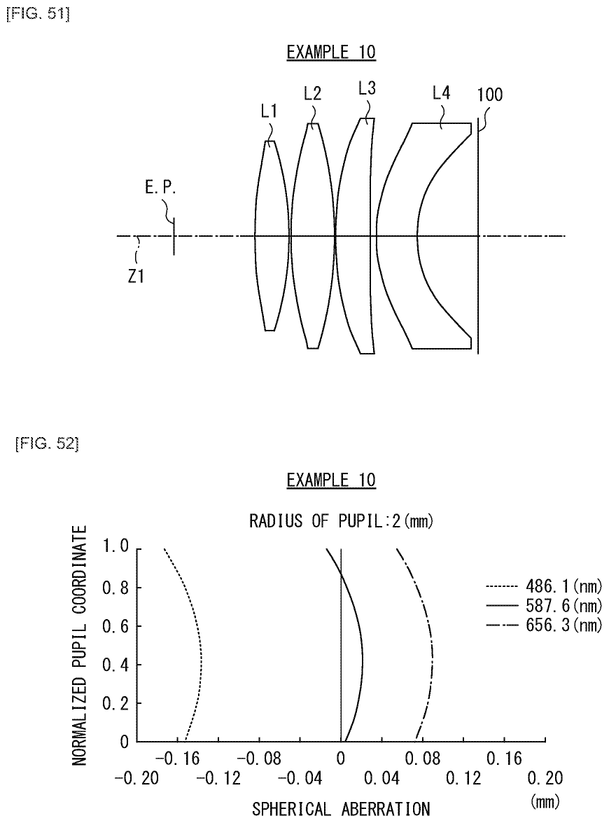

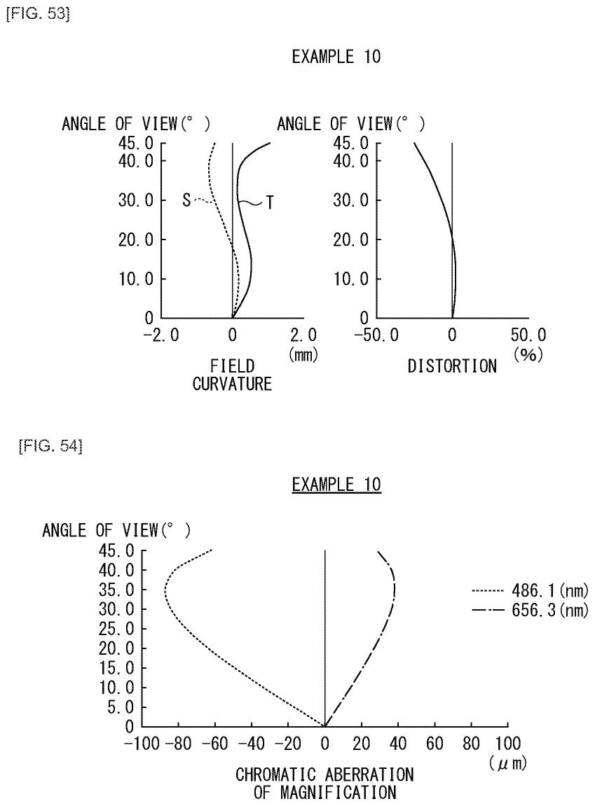

FIG. 51 illustrates a lens cross-section of the eyepiece according to Example 10. FIGS. 52 to 54 illustrate various aberrations of the eyepiece according to Example 10.

As can be appreciated from each of the aberration diagrams, it is obvious that the eyepiece according to Example 10 has favorable optical performance.

### Example 11

Table 23 exhibits basic lens data of an eyepiece according to Example 11. In addition, Table 24 exhibits aspherical surface data.

TABLE 23
Example 11 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 67.726 | 6.455 | 1.755 | 52.3 |
| 3 | −55.571 | 0.200 | — | — |
| 4 | 46.556 | 7.204 | 1.533 | 56.0 |
| 5 | −50.727 | 0.200 | — | — |
| 6 | 44.281 | 6.731 | 1.533 | 56.0 |
| 7 | −179.780 | 0.200 | — | — |
| 8 | −585.688 | 6.937 | 1.661 | 20.4 |
| 9 | 41.525 | 5.839 | — | — |
| 10 | ∞ | — | — | — |

TABLE 24
Example 11 Aspherical Surface Data

| Si | k | | | | |
|---|---|---|---|---|---|
| Surface | Conic | | | | |
| No. | Constant | A3 | A4 | A5 | A6 |
| 4 | −4.827 | −2.907E−06 | −3.157E−07 | −2.239E−08 | 2.244E−09 |
| 5 | 0.875 | 2.571E−05 | 8.563E−06 | 8.411E−08 | −1.886E−10 |
| 6 | 3.591 | 1.789E−05 | 8.804E−06 | −1.690E−07 | 2.149E−09 |
| 7 | −212.424 | 1.680E−04 | 7.092E−06 | 1.048E−08 | −9.291E−10 |
| 8 | −1145.499 | 1.197E−04 | 5.358E−06 | −1.551E−08 | 9.714E−10 |
| 9 | −60.986 | 1.512E−03 | −2.422E−05 | −2.632E−07 | 3.304E−08 |

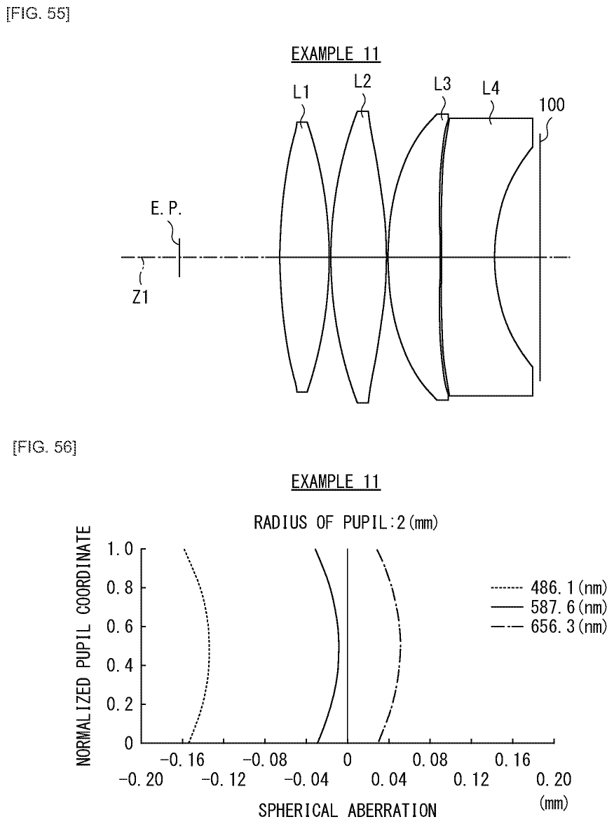

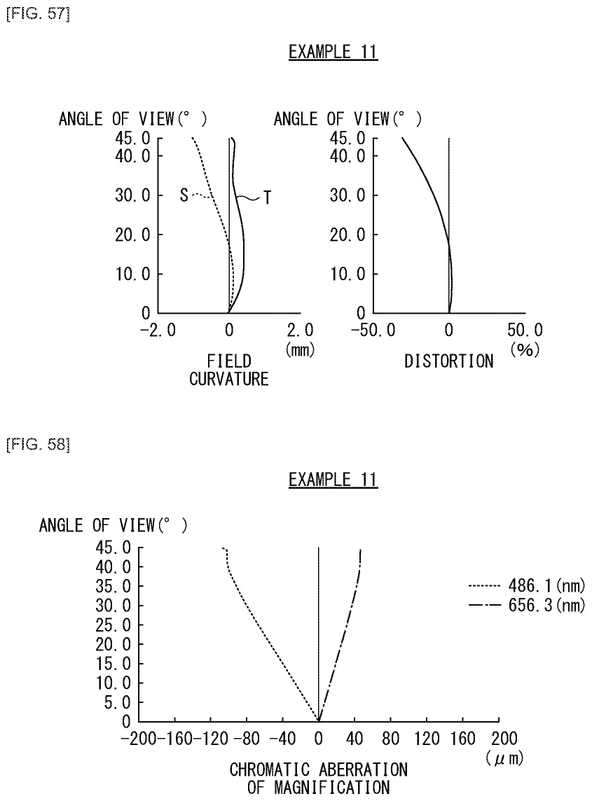

FIG. 55 illustrates a lens cross-section of the eyepiece according to Example 11. FIGS. 56 to 58 illustrate various aberrations of the eyepiece according to Example 11.

As can be appreciated from each of the aberration diagrams, it is obvious that the eyepiece according to Example 11 has favorable optical performance.

### Example 12

Table 25 exhibits basic lens data of an eyepiece according to Example 12. In addition, Table 26 exhibits aspherical surface data.

TABLE 25
Example 12 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 15.000 | — | — |
| 2 | 138.374 | 4.427 | 1.877 | 40.8 |
| 3 | −55.971 | 0.200 | — | — |
| 4 | 37.655 | 7.629 | 1.533 | 56.0 |
| 5 | −483.220 | 0.200 | — | — |
| 6 | 40.249 | 10.787 | 1.533 | 56.0 |
| 7 | −754.713 | 0.200 | — | — |
| 8 | 65.846 | 5.413 | 1.661 | 20.4 |
| 9 | 138.374 | 4.427 | — | — |
| 10 | ∞ | — | — | — |

TABLE 26
Example 12 Aspherical Surface Data

| Si | k | | | | |
|---|---|---|---|---|---|
| Surface | Conic | | | | |
| No. | Constant | A3 | A4 | A5 | A6 |
| 4 | −0.047 | −4.190E−05 | −1.068E−07 | −4.412E−08 | −3.401E−09 |
| 5 | 309.814 | 1.027E−05 | −4.222E−06 | 4.518E−08 | 3.366E−09 |
| 6 | 1.968 | 1.112E−04 | 7.927E−06 | 2.530E−08 | −1.356E−10 |
| 7 | 280.220 | 1.480E−05 | −1.067E−06 | −1.637E−09 | 4.450E−10 |
| 8 | 7.781 | −4.710E−04 | −6.040E−06 | −2.850E−07 | 3.228E−08 |
| 9 | 0.000 | 2.732E−04 | 8.317E−05 | 2.725E−06 | −2.529E−07 |

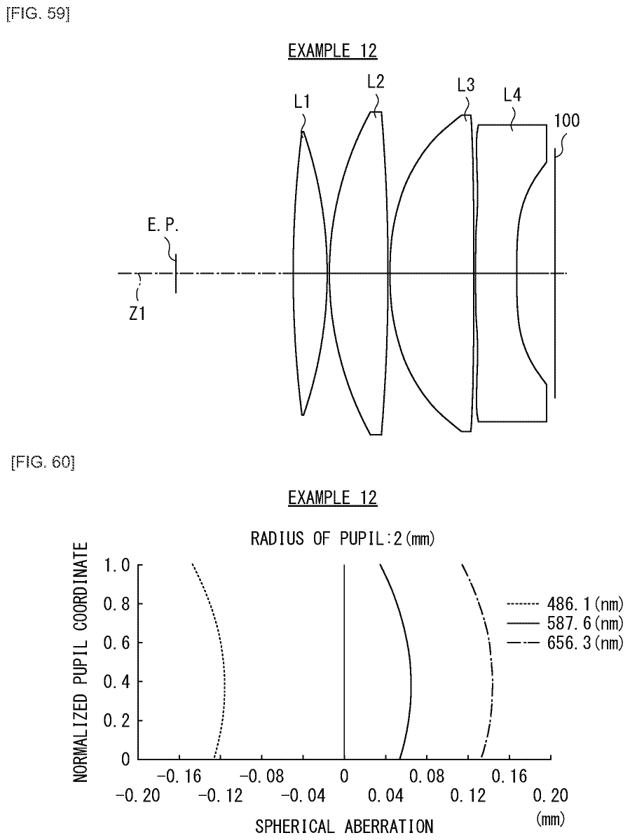

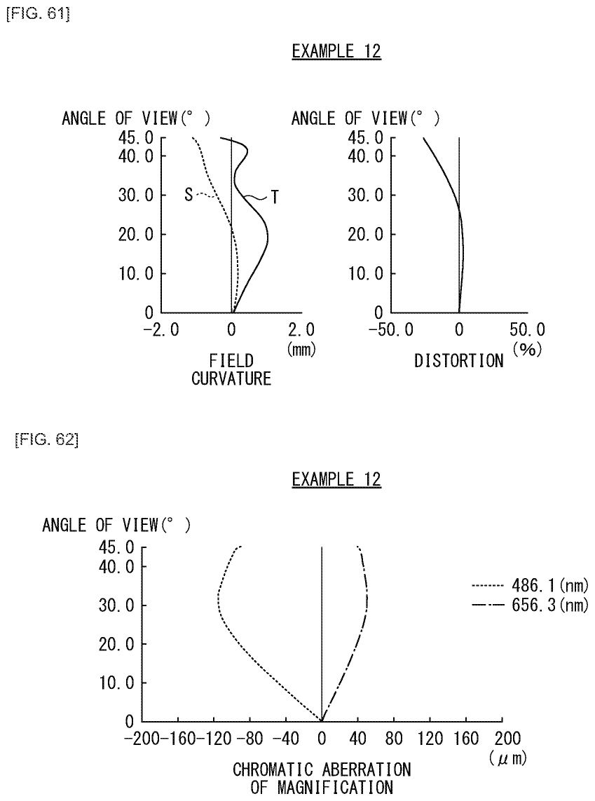

FIG. 59 illustrates a lens cross-section of the eyepiece according to Example 12. FIGS. 60 to 62 illustrate various aberrations of the eyepiece according to Example 12.

As can be appreciated from each of the aberration diagrams, it is obvious that the eyepiece according to Example 12 has favorable optical performance.

### Example 13

Table 27 exhibits basic lens data of an eyepiece according to Example 13. In addition, Table 28 exhibits aspherical surface data.

TABLE 27
Example 13 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 63.290 | 5.726 | 1.755 | 52.3 |
| 3 | −60.847 | 0.182 | — | — |
| 4 | 38.788 | 7.566 | 1.533 | 56.0 |
| 5 | −200.451 | 0.186 | — | — |
| 6 | 33.026 | 10.378 | 1.533 | 56.0 |
| 7 | −19.773 | 0.148 | — | — |
| 8 | −69.532 | 4.787 | 1.661 | 20.4 |
| 9 | 28.638 | 3.890 | — | — |
| 10 | ∞ | — | — | — |

TABLE 28
Example 13 Aspherical Surface Data

| Si | k | | | | |
|---|---|---|---|---|---|
| Surface | Conic | | | | |
| No. | Constant | A3 | A4 | A5 | A6 |
| 4 | −0.485 | 6.752E−05 | 2.525E−06 | −2.309E−08 | −7.577E−10 |
| 5 | −0.737 | −1.038E−04 | 6.313E−06 | 2.636E−08 | 4.954E−10 |
| 6 | 1.514 | −2.920E−04 | 7.486E−06 | 6.367E−08 | 1.161E−09 |
| 7 | −6.704 | 3.420E−04 | 2.044E−05 | −2.107E−08 | −1.956E−09 |
| 8 | 3.856 | −3.386E−04 | 3.365E−05 | 0.000E+00 | 0.000E+00 |
| 9 | −2.421 | −3.289E−05 | −8.622E−06 | 7.208E−08 | 3.470E−09 |

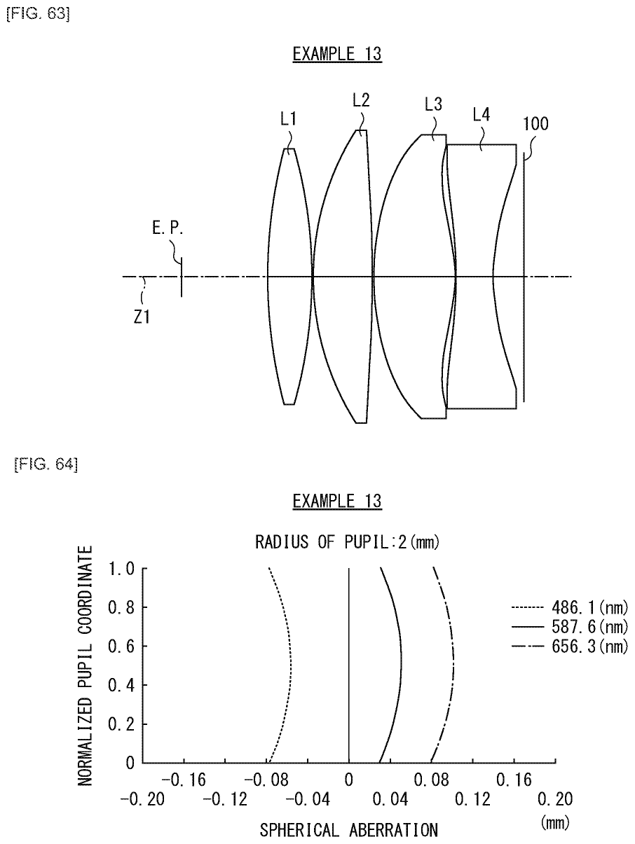

FIG. 63 illustrates a lens cross-section of the eyepiece according to Example 13. FIGS. 64 to 66 illustrate various aberrations of the eyepiece according to Example 13.

As can be appreciated from each of the aberration diagrams, it is obvious that the eyepiece according to Example 13 has favorable optical performance.

### Example 14

Table 29 exhibits basic lens data of an eyepiece according to Example 14. In addition, Table 30 exhibits aspherical surface data.

TABLE 29
Example 14 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 72.775 | 7.377 | 1.755 | 52.3 |
| 3 | −53.934 | 0.167 | — | — |
| 4 | 39.529 | 8.315 | 1.533 | 56.0 |
| 5 | −153.936 | 0.176 | — | — |
| 6 | 37.292 | 10.587 | 1.533 | 56.0 |
| 7 | −19.022 | 0.186 | — | — |
| 8 | −78.594 | 5.623 | 1.661 | 20.4 |
| 9 | 22.466 | 3.147 | — | — |
| 10 | ∞ | — | — | — |

TABLE 30
Example 14 Aspherical Surface Data

| Si | k | | | | |
|---|---|---|---|---|---|
| Surface | Conic | | | | |
| No. | Constant | A3 | A4 | A5 | A6 |
| 4 | −0.473 | 6.420E−05 | 2.473E−06 | −2.179E−08 | −6.995E−10 |
| 5 | 34.057 | −3.285E−05 | 7.668E−06 | 1.024E−07 | 4.229E−09 |
| 6 | 1.262 | −2.257E−04 | 8.607E−06 | 8.308E−08 | 3.623E−09 |
| 7 | −10.816 | 2.212E−04 | 1.385E−05 | −2.650E−08 | −8.293E−09 |
| 8 | 3.155 | −2.546E−04 | 3.130E−05 | −1.616E−07 | 2.048E−08 |
| 9 | −7.052 | −1.355E−04 | −1.987E−05 | 7.022E−08 | 1.136E−08 |

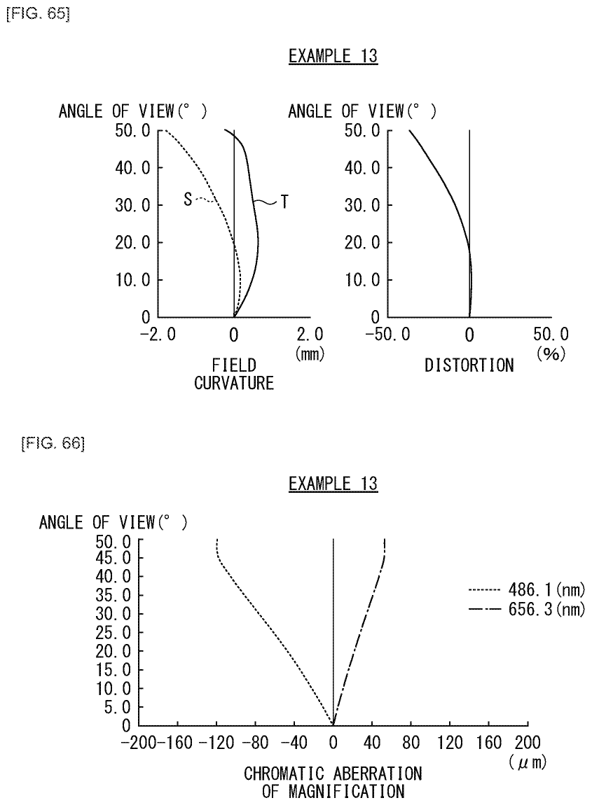

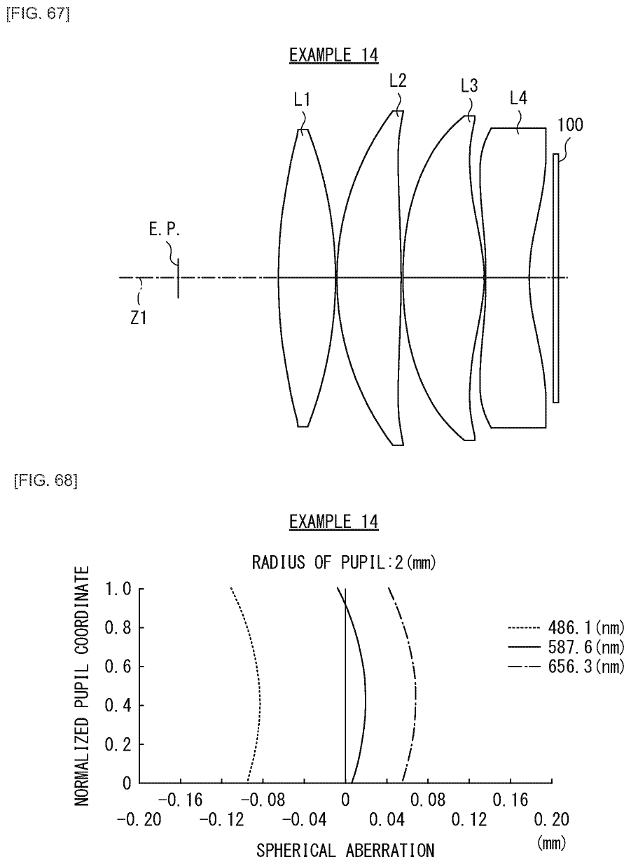

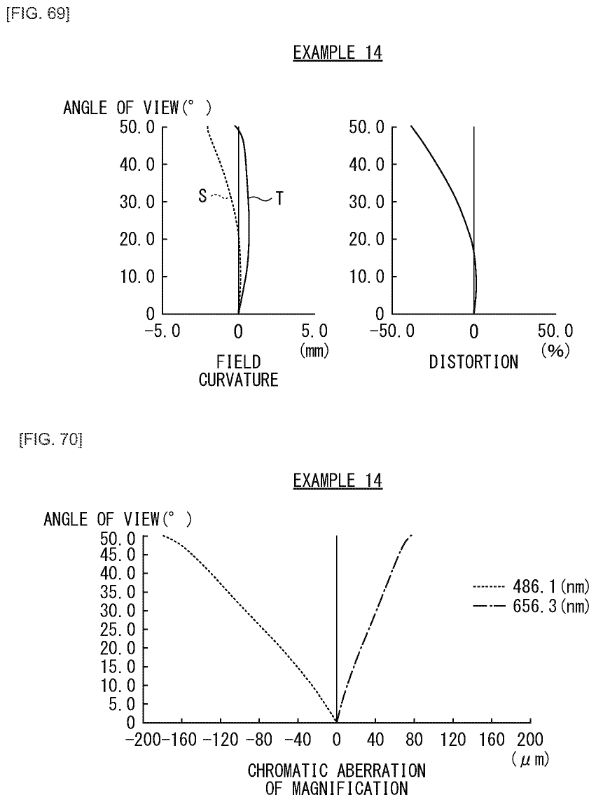

FIG. 67 illustrates a lens cross-section of the eyepiece according to Example 14. FIGS. 68 to 70 illustrate various aberrations of the eyepiece according to Example 14.

As can be appreciated from each of the aberration diagrams, it is obvious that the eyepiece according to Example 14 has favorable optical performance.

### Example 15

Table 31 exhibits basic lens data of an eyepiece according to Example 15. In addition, Table 32 exhibits aspherical surface data.

TABLE 31
Example 15 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 15.000 | — | — |
| 2 | 90.034 | 6.939 | 1.877 | 40.8 |
| 3 | −56.130 | 0.200 | — | — |
| 4 | 40.666 | 7.933 | 1.533 | 56.0 |
| 5 | 149.099 | 0.200 | — | — |
| 6 | 25.215 | 6.569 | 1.533 | 56.0 |
| 7 | 52.038 | 0.200 | — | — |
| 8 | 37.185 | 11.059 | 1.661 | 20.4 |
| 9 | 96.372 | 2.487 | — | — |
| 10 | ∞ | — | — | — |

TABLE 32
Example 15 Aspherical Surface Data

| Si | k | | | | |
|---|---|---|---|---|---|
| Surface | Conic | | | | |
| No. | Constant | A3 | A4 | A5 | A6 |
| 4 | 0.700 | 8.841E−05 | 2.309E−06 | −2.090E−08 | −5.198E−09 |
| 5 | −48.565 | −1.401E−04 | 4.871E−07 | 1.354E−07 | 9.277E−09 |
| 6 | −0.019 | −2.569E−04 | −2.195E−07 | −1.174E−07 | 9.246E−09 |
| 7 | 0.231 | 1.315E−04 | 3.795E−07 | 7.732E−08 | −1.077E−08 |
| 8 | 1.942 | −2.064E−04 | −9.604E−06 | 2.071E−07 | 1.278E−08 |
| 9 | −12.070 | −1.967E−04 | −6.468E−06 | 1.570E−06 | −4.676E−09 |

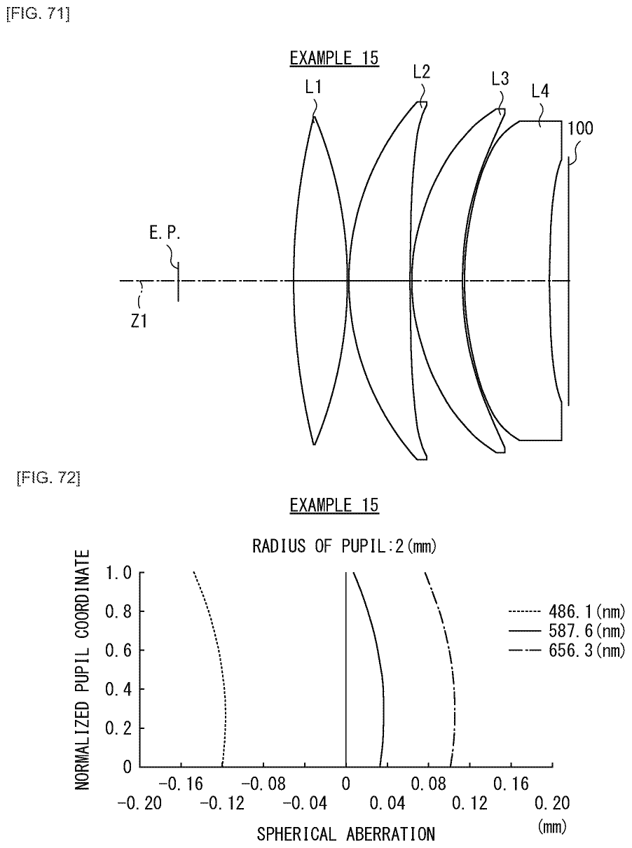

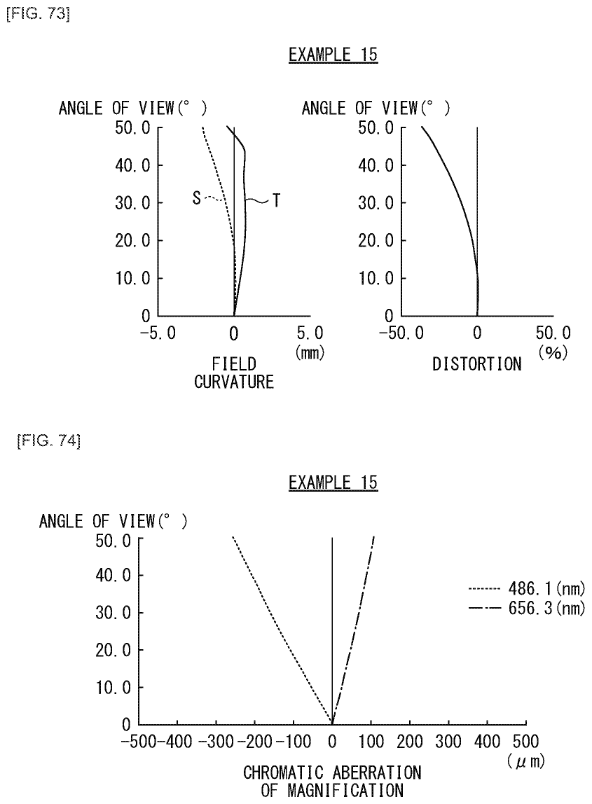

FIG. 71 illustrates a lens cross-section of the eyepiece according to Example 15. FIGS. 72 to 74 illustrate various aberrations of the eyepiece according to Example 15.

As can be appreciated from each of the aberration diagrams, it is obvious that the eyepiece according to Example 15 has favorable optical performance.

### Example 16

Table 33 exhibits basic lens data of an eyepiece according to Example 16. In addition, Table 34 exhibits aspherical surface data.

TABLE 33
Example 16 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | 128.908 | 6.690 | 1.877 | 40.8 |
| 3 | −41.619 | 0.200 | — | — |
| 4 | 30.564 | 8.413 | 1.533 | 56.0 |
| 5 | −239.276 | 0.200 | — | — |
| 6 | 41.795 | 7.214 | 1.533 | 56.0 |
| 7 | 66.009 | 0.200 | — | — |
| 8 | 44.429 | 8.334 | 1.533 | 56.0 |
| 9 | 119.502 | 1.756 | — | — |
| 10 | ∞ | — | — | — |

TABLE 34
Example 16 Aspherical Surface Data

| Si | k | | | | |
|---|---|---|---|---|---|
| Surface | Conic | | | | |
| No. | Constant | A3 | A4 | A5 | A6 |
| 4 | −1.118 | 8.061E−06 | 1.884E−07 | −7.294E−09 | −1.043E−09 |
| 5 | 0.000 | 1.109E−05 | 1.030E−06 | 4.043E−08 | 9.564E−10 |
| 6 | 1.751 | 8.254E−05 | 1.905E−06 | 8.305E−08 | 4.959E−09 |
| 7 | −1.932 | −4.545E−05 | 3.275E−07 | 2.811E−08 | −5.025E−10 |
| 8 | 4.037 | −1.154E−04 | −8.277E−06 | −6.309E−08 | 2.354E−08 |
| 9 | 43.457 | −1.249E−04 | −4.366E−06 | −9.743E−08 | 1.127E−08 |

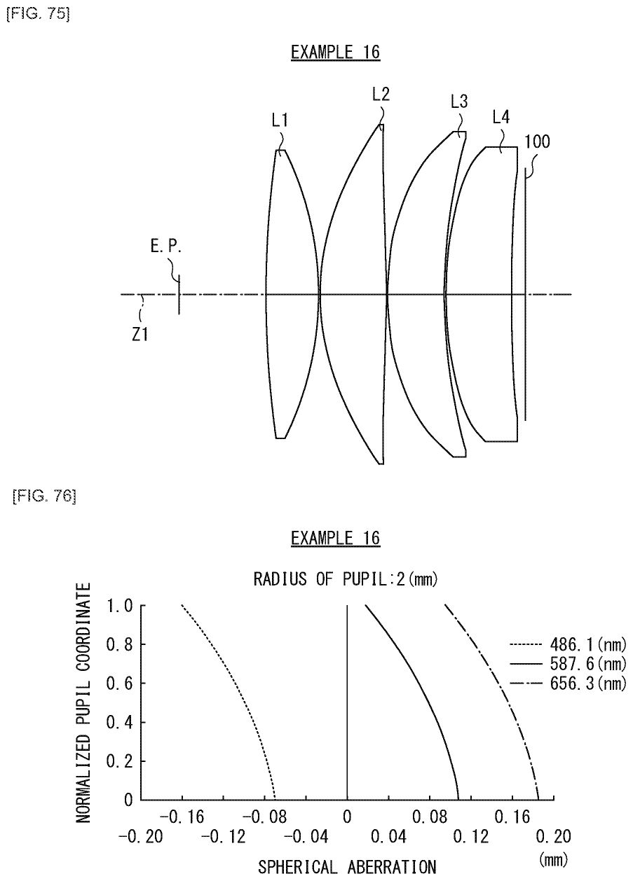

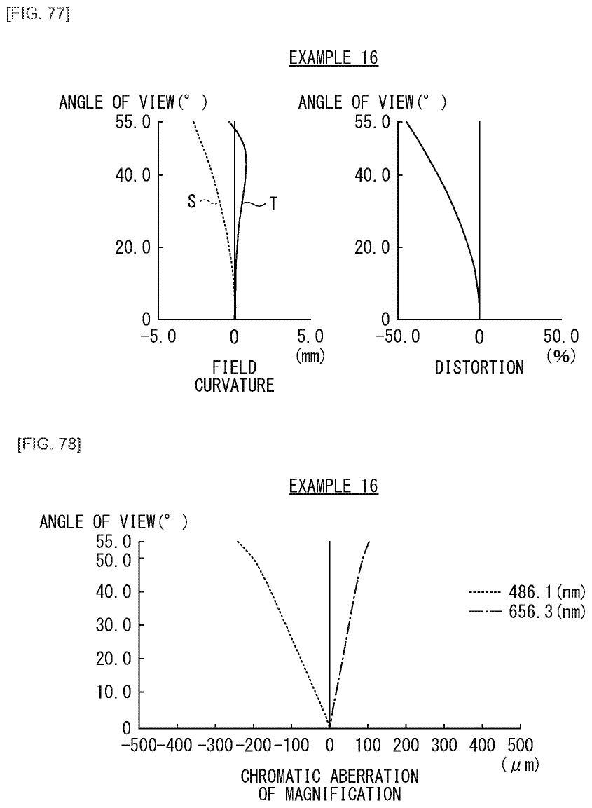

FIG. 75 illustrates a lens cross-section of the eyepiece according to Example 16. FIGS. 76 to 78 illustrate various aberrations of the eyepiece according to Example 16.

As can be appreciated from each of the aberration diagrams, it is obvious that the eyepiece according to Example 16 has favorable optical performance.

### Example 17

Table 35 exhibits basic lens data of an eyepiece according to Example 17. In addition, Table 36 exhibits aspherical surface data.

TABLE 35
Example 17 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 13.000 | — | — |
| 2 | 246.051 | 7.614 | 1.877 | 40.8 |
| 3 | −37.639 | 0.200 | — | — |
| 4 | 42.990 | 7.116 | 1.533 | 56.0 |
| 5 | ∞ | 0.200 | — | — |
| 6 | 110.080 | 8.310 | 1.533 | 56.0 |
| 7 | −42.981 | 0.200 | — | — |
| 8 | 44.708 | 9.903 | 1.661 | 20.4 |
| 9 | 144.592 | 2.698 | — | — |
| 10 | ∞ | — | — | — |

TABLE 36
Example 17 Aspherical Surface Data

| Si | k | | | | |
|---|---|---|---|---|---|
| Surface | Conic | | | | |
| No. | Constant | A3 | A4 | A5 | A6 |
| 4 | 1.332 | 1.402E−04 | −4.682E−06 | −1.395E−07 | −5.963E−09 |
| 5 | 0.000 | 2.865E−05 | 1.104E−06 | 8.414E−09 | −6.052E−10 |
| 6 | 13.659 | 1.055E−04 | 3.725E−06 | 2.236E−08 | 1.823E−10 |
| 7 | −362.458 | 3.544E−05 | 2.436E−07 | −3.522E−08 | −1.009E−09 |
| 8 | 4.569 | 3.808E−04 | 5.723E−07 | −3.685E−07 | 1.217E−08 |
| 9 | 17.232 | 3.464E−04 | 2.154E−06 | −1.139E−07 | −2.220E−08 |

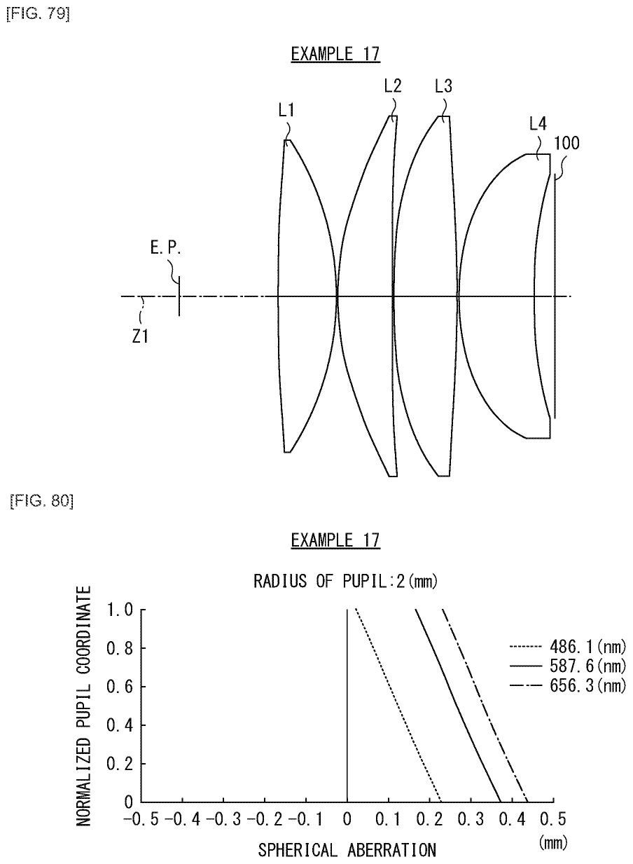

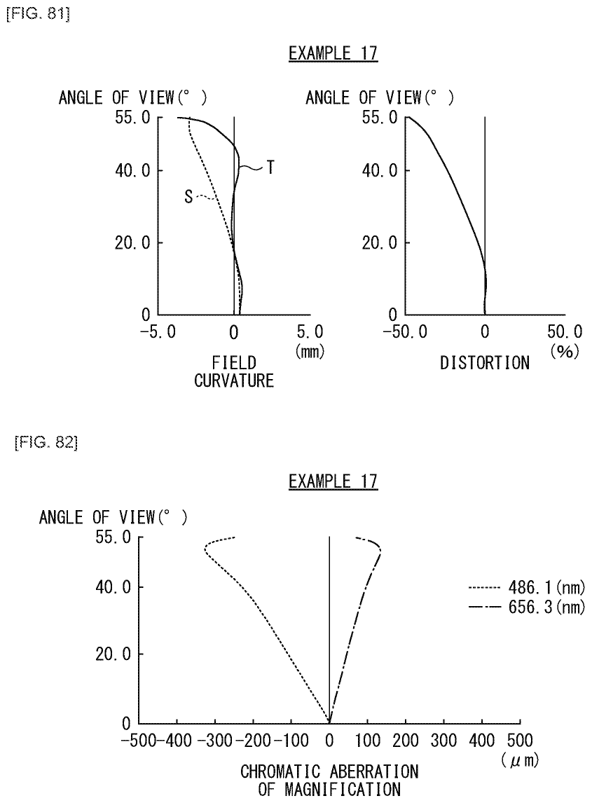

FIG. 79 illustrates a lens cross-section of the eyepiece according to Example 17. FIGS. 80 to 82 illustrate various aberrations of the eyepiece according to Example 17.

As can be appreciated from each of the aberration diagrams, it is obvious that the eyepiece according to Example 17 has favorable optical performance.

### Example 18

Table 37 exhibits basic lens data of an eyepiece according to Example 18. In addition, Table 38 exhibits aspherical surface data.

TABLE 37
Example 18 Lens Data

| Si | Ri | | Ndi | νdi |
|---|---|---|---|---|
| Surface | Curvature | Di | Refractive | Abbe's |
| No. | Radius | interval | Index | Number |
| 1 (STO) | ∞ | 11.000 | — | — |
| 2 | ∞ | 2.635 | 1.755 | 52.3 |
| 3 | −53.599 | 0.200 | — | — |
| 4 | 54.153 | 4.038 | 1.877 | 40.8 |
| 5 | −118.696 | 5.502 | — | — |
| 6 | 45.254 | 5.644 | 1.755 | 52.3 |
| 7 | −122.125 | 0.199 | — | — |
| 8 | 93.843 | 5.990 | 1.661 | 20.4 |
| 9 | 66.320 | 6.105 | — | — |
| 10 | ∞ | — | — | — |

TABLE 38
Example 18 Aspherical Surface Data

| Si | k | | | | |
|---|---|---|---|---|---|
| Surface | Conic | | | | |
| No. | Constant | A3 | A4 | A5 | A6 |
| 8 | 11.474 | −5.871E−04 | 2.192E−04 | −2.027E−05 | 5.094E−07 |
| 9 | −1359.145 | 1.918E−03 | 2.139E−04 | −2.506E−05 | 6.480E−07 |

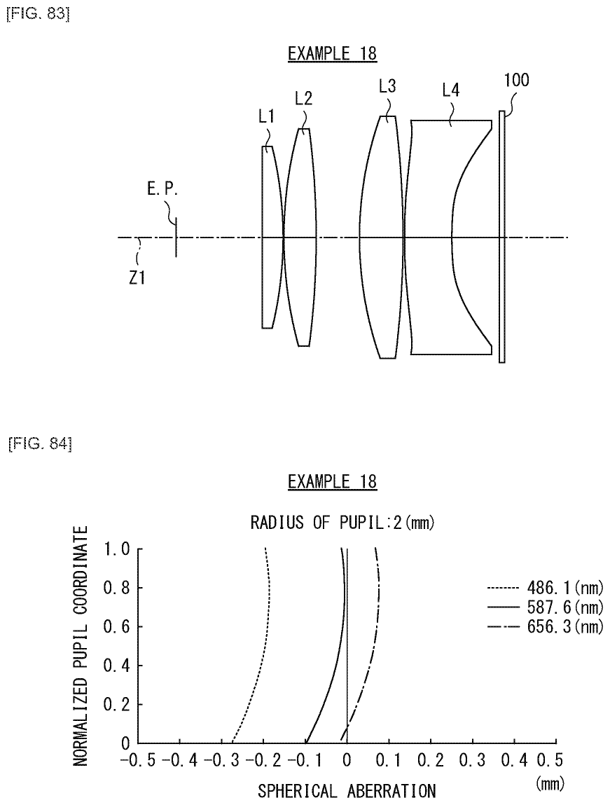

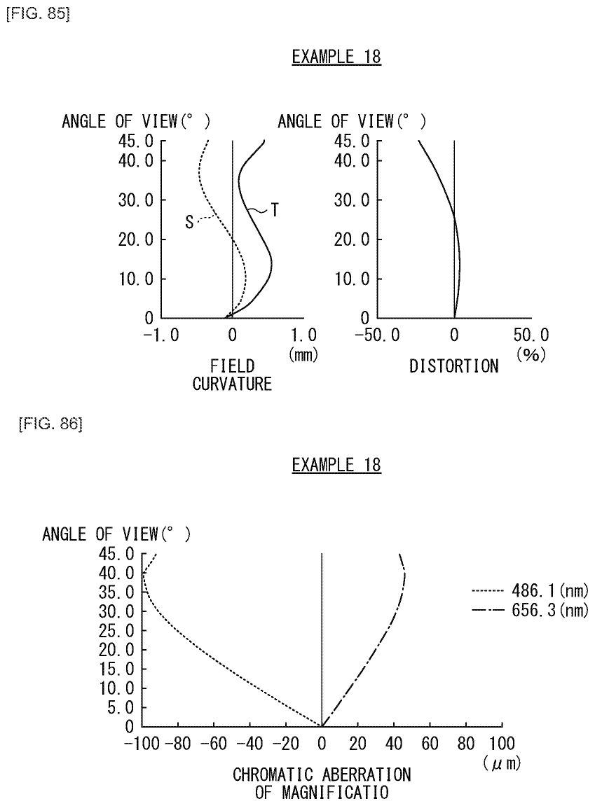

FIG. 83 illustrates a lens cross-section of the eyepiece according to Example 18. FIGS. 84 to 86 illustrate various aberrations of the eyepiece according to Example 18.

As can be appreciated from each of the aberration diagrams, it is obvious that the eyepiece according to Example 18 has favorable optical performance.

### [Other Numerical Data of Respective Examples]

Tables 39 and 40 exhibit, in a summarized manner for respective examples, specifications of the eyepieces according to the respective examples and values of other numerical data (such as values concerning conditional expressions) satisfied by the eyepieces according to the respective examples. It is to be noted that L denotes a total length (a distance from the eye point E.P. to the image (image display device 100)). As can be appreciated from Tables 39 and 40, desired configurations are satisfied for the respective examples. As exhibited in Tables 39 and 40, the image magnification My of each of the examples is twice or more. In addition, in each of the examples, a refractive index of the first lens L1 with respect to the d-line is 1.439 or more. In addition, in each of the examples, relationships of the conditional expressions (1A), (2A), (1B), and (2B) are satisfied.

TABLE 39

| | Example | Example | Example | Example | Example |
|---|---|---|---|---|---|
| | 1 | 2 | 3 | 4 | 5 |
| Lens | 3-Group | 3-Group | 3-Group | 3-Group | 3-Group |
| Configuration | 3-Lens | 3-Lens | 3-Lens | 3-Lens | 3-Lens |
| L [mm] | 41.7758 | 46.0373 | 51.1723 | 42.9278 | 48.1707 |
| f [mm] | 18.7120 | 18.1817 | 21.8441 | 18.6291 | 18.8851 |
| Mv | 2.138 | 2.337 | 2.580 | 2.435 | 2.709 |
| f/L′ | 0.622 | 0.562 | 0.616 | 0.597 | 0.548 |
| t′/L′ | 0.709 | 0.771 | 0.844 | 0.811 | 0.882 |
| Refractive | 1.439 | 1.755 | 1.877 | 1.755 | 1.755 |
| Index of L1 | | | | | |
| Shape of L1 on | Convex | Convex | Convex | Convex | Convex |
| E.P. Side | | | | | |
| Maximum | 160 | 205 | 300 | 218 | 300 |
| Chromatic | | | | | |
| Aberration of | | | | | |
| Magnification | | | | | |
| [μm] | | | | | |

| | Example | Example | Example | Example |
|---|---|---|---|---|
| | 6 | 7 | 8 | 9 |
| Lens | 3-Group | 3-Group | 3-Group | 3-Group |
| Configuration | 3-Lens | 3-Lens | 3-Lens | 3-Lens |
| L [mm] | 50.3993 | 44.7761 | 48.5817 | 40.1650 |
| f [mm] | 18.0808 | 17.6077 | 17.3428 | 21.7047 |
| Mv | 2.826 | 2.784 | 3.003 | 2.521 |
| f/L′ | 0.521 | 0.532 | 0.497 | 0.763 |
| t′/L′ | 0.904 | 0.923 | 0.952 | 0.457 |
| Refractive | 1.877 | 1.877 | 1.877 | 1.755 |
| Index of L1 | | | | |
| Shape of L1 on | Convex | Convex | Convex | Flat |
| E.P. Side | | | | |
| Maximum | 395 | 370 | 530 | 210 |
| Chromatic | | | | |
| Aberration of | | | | |
| Magnification | | | | |
| [μm] | | | | |

TABLE 40

| | Example | Example | Example | Example | Example |
|---|---|---|---|---|---|
| | 10 | 11 | 12 | 13 | 14 |
| Lens | 4-Group | 4-Group | 4-Group | 4-Group | 4-Group |
| Configuration | 4-Lens | 4-Lens | 4-Lens | 4-Lens | 4-Lens |
| L [mm] | 42.0217 | 47.4668 | 49.3563 | 44.5636 | 49.2783 |
| f [mm] | 19.2993 | 20.5282 | 19 | 18.8122 | 19.2299 |
| Mv | 2.149 | 2.405 | 2.494 | 2.520 | 2.767 |
| f/L′ | 0.636 | 0.608 | 0.571 | 0.572 | 0.540 |
| t′/L′ | 0.690 | 0.809 | 0.840 | 0.852 | 0.897 |
| Refractive | 1.439 | 1.755 | 1.877 | 1.755 | 1.755 |
| Index of L1 | | | | | |
| Shape of L1 on | Convex | Convex | Convex | Convex | Convex |
| E.P. Side | | | | | |
| Maximum | 125 | 156 | 166 | 175 | 255 |
| Chromatic | | | | | |
| Aberration of | | | | | |
| Magnification | | | | | |
| [μm] | | | | | |

| | Example | Example | Example | Example |
|---|---|---|---|---|
| | 15 | 16 | 17 | 18 |
| Lens | 4-Group | 4-Group | 4-Group | 4-Group |
| Configuration | 4-Lens | 4-Lens | 4-Lens | 4-Lens |
| L [mm] | 51.2875 | 44.7073 | 49.9410 | 42.0129 |
| f [mm] | 18.6894 | 17.7986 | 17.6182 | 18.7496 |
| Mv | 2.872 | 2.780 | 3.082 | 2.626 |
| f/L′ | 0.525 | 0.539 | 0.486 | 0.619 |
| t′/L′ | 0.913 | 0.929 | 0.909 | 0.604 |
| Refractive | 1.877 | 1.877 | 1.877 | 1.755 |
| Index of L1 | | | | |
| Shape of L1 on | Convex | Convex | Convex | Flat |
| E.P. Side | | | | |
| Maximum | 365 | 350 | 465 | 146 |
| Chromatic | | | | |
| Aberration of | | | | |
| Magnification | | | | |
| [μm] | | | | |

### 5. Other Embodiments

The technique according to the present disclosure is not limited to the description of the foregoing embodiments and examples, and may be modified and worked in a wide variety of ways.

For example, shapes and numerical values of the respective parts illustrated in each of the above numerical examples are each a mere example of implementation of the present technology, and the technical scope of the present technology should not be construed as being limited by these examples.

In addition, although the description has been given, in the foregoing embodiments and examples, of the configuration substantially including three or four lenses, a configuration may be employed that further includes a lens having no substantial refractive power.

In addition, a surface forming an aspherical surface is not limited to the lens surfaces exhibited in the respective examples; a surface other than the lens surfaces exhibited in the respective examples may be an aspherical surface.

In addition, for example, the present technology may have the following configurations.

According to the present technology having the following configurations, the configuration of the plurality of single lenses is optimized that configure the eyepiece optical system in a manner to include an aspherical lens including a resin material, and a display image for correction of distortion and chromatic aberration of magnification generated in the eyepiece optical system is displayed. This makes it possible to provide high-definition beauty of an image while achieving a lighter weight and a wider angle of view.

[1]

A display apparatus including an eyepiece display unit including an image display device and an eyepiece optical system that guides a display image displayed on the image display device to an eye point,

an image magnification by the eyepiece optical system being twice or more,

the eyepiece optical system including a coaxial system including a plurality of single lenses,

at least one of the plurality of single lenses including an aspherical lens including a resin material, and

the image display device displaying, as the display image, an image for correction of distortion and chromatic aberration of magnification generated in the eyepiece optical system.

[2]

The display apparatus according to [1], in which the eyepiece optical system includes an eyepiece of a three-group three-lens configuration in which a first lens, a second lens, and a third lens are arranged as the plurality of single lenses in order from side of the eye point toward side of an image.

[3]

The display apparatus according to [2], in which

the first lens includes a spherical lens having a positive refractive power including a material of a refractive index of 1.439 or more with respect to a d-line, and

a lens surface of the first lens on the side of the eye point has a convex shape or a planar shape.

[4]

The display apparatus according to [2] or [3], in which a maximum amount of generation of the chromatic aberration of magnification in the eyepiece optical system is 600 μm or less.

[5]

The display apparatus according to any one of [2] to [4], in which the following conditional expression:

0.450<f/L′<0.800 (1A)

is satisfied, where

f denotes an effective focal length, and

L′ denotes a distance from a lens surface on side closest to the eye point in the plurality of single lenses to the image.

[6]

The display apparatus according to any one of [2] to [5], in which the following conditional expression:

0.400<t′/L′ (2A)

is satisfied, where

t′ denotes a summation of respective center thicknesses of the plurality of single lenses, and

L′ denotes the distance from the lens surface on the side closest to the eye point in the plurality of single lenses to the image.

[7]

The display apparatus according to [1], in which the eyepiece optical system includes an eyepiece of a four-group four-lens configuration in which a first lens, a second lens, a third lens, and a fourth lens are arranged as the plurality of single lenses in order from side of the eye point toward side of an image.

[8]

The display apparatus according to [7], in which

the first lens includes a spherical lens having a positive refractive power including a material of a refractive index of 1.439 or more with respect to a d-line, and

a lens surface of the first lens on the side of the eye point has a convex shape or a planar shape.

[9]

The display apparatus according to [7] or [8], in which a maximum amount of generation of the chromatic aberration of magnification in the eyepiece optical system is 600 μm or less.

[10]

The display apparatus according to any one of [7] to [9], in which the following conditional expression:

0.450<f/L′<0.700 (1B)

is satisfied, where

f denotes an effective focal length, and

L′ denotes a distance from a lens surface on side closest to the eye point in the plurality of single lenses to the image.

[11]

The display apparatus according to any one of [7] to [10], in which the following conditional expression:

0.550<t′/L′ (2B)

is satisfied, where

t′ denotes a summation of respective center thicknesses of the plurality of single lenses, and

L′ denotes the distance from the lens surface on the side closest to the eye point in the plurality of single lenses to the image.

[12]

The display apparatus according to any one of [1] to [11], in which

the eyepiece display unit includes a left eyepiece display unit and a right eyepiece display unit,

the image display device includes a left-eye image display device arranged in the left eyepiece display unit, and a right-eye image display device arranged in the right eyepiece display unit,

the eyepiece optical system includes a left eyepiece optical system and a right eyepiece optical system, the left eyepiece optical system being arranged in the left eyepiece display unit and guiding a left-eye display image displayed on the left-eye image display device to a left eye, the right eyepiece optical system being arranged in the right eyepiece display unit and guiding a right-eye display image displayed on the right-eye image display device to a right eye, the left eyepiece optical system and the right eyepiece optical system each include the plurality of single lenses, and

an image magnification upon observation by both eyes is twice or more.

This application claims the benefit of Japanese priority Patent Application JP2018-143853 filed with the Japan Patent Office on Jul. 31, 2018, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display apparatus comprising an eyepiece display unit including an image display device and an eyepiece optical system that guides a display image displayed on the image display device to an eye point,
an image magnification by the eyepiece optical system being twice or more,
the eyepiece optical system comprising a coaxial system including a plurality of single lenses,
at least one of the plurality of single lenses comprising an aspherical lens including a resin material, and
the image display device displaying, as the display image, an image for correction of distortion and chromatic aberration of magnification generated in the eyepiece optical system.

2. The display apparatus according to claim 1, wherein the eyepiece optical system includes an eyepiece of a three-group three-lens configuration in which a first lens, a second lens, and a third lens are arranged as the plurality of single lenses in order from side of the eye point toward side of an image.

3. The display apparatus according to claim 2, wherein
the first lens comprises a spherical lens having a positive refractive power including a material of a refractive index of 1.439 or more with respect to a d-line, and
a lens surface of the first lens on the side of the eye point has a convex shape or a planar shape.

4. The display apparatus according to claim 2, wherein a maximum amount of generation of the chromatic aberration of magnification in the eyepiece optical system is 600 μm or less.

5. The display apparatus according to claim 2, wherein the following conditional expression:
0.450<f/L′<0.800 (1A)
is satisfied, where
f denotes an effective focal length, and
L′ denotes a distance from a lens surface on side closest to the eye point in the plurality of single lenses to the image.

6. The display apparatus according to claim 2, wherein the following conditional expression:
0.400<t′/L′ (2A)
is satisfied, where
t′ denotes a summation of respective center thicknesses of the plurality of single lenses, and
L′ denotes a distance from a lens surface on side closest to the eye point in the plurality of single lenses to the image.

7. The display apparatus according to claim 1, wherein the eyepiece optical system includes an eyepiece of a four-group four-lens configuration in which a first lens, a second lens, a third lens, and a fourth lens are arranged as the plurality of single lenses in order from side of the eye point toward side of an image.

8. The display apparatus according to claim 7, wherein
the first lens comprises a spherical lens having a positive refractive power including a material of a refractive index of 1.439 or more with respect to a d-line, and
a lens surface of the first lens on the side of the eye point has a convex shape or a planar shape.

9. The display apparatus according to claim 7, wherein a maximum amount of generation of the chromatic aberration of magnification in the eyepiece optical system is 600 μm or less.

10. The display apparatus according to claim 7, wherein the following conditional expression:
0.450<f/L′<0.700 (1B)
is satisfied, where
f denotes an effective focal length, and
L′ denotes a distance from a lens surface on side closest to the eye point in the plurality of single lenses to the image.

11. The display apparatus according to claim 7, wherein the following conditional expression:
0.550<t′/L′ (2B)
is satisfied, where
t′ denotes a summation of respective center thicknesses of the plurality of single lenses, and
L′ denotes a distance from a lens surface on side closest to the eye point in the plurality of single lenses to the image.

12. The display apparatus according to claim 1, wherein
the eyepiece display unit includes a left eyepiece display unit and a right eyepiece display unit,
the image display device includes a left-eye image display device arranged in the left eyepiece display unit, and a right-eye image display device arranged in the right eyepiece display unit,
the eyepiece optical system includes a left eyepiece optical system and a right eyepiece optical system, the left eyepiece optical system being arranged in the left eyepiece display unit and guiding a left-eye display image displayed on the left-eye image display device to a left eye, the right eyepiece optical system being arranged in the right eyepiece display unit and guiding a right-eye display image displayed on the right-eye image display device to a right eye,
the left eyepiece optical system and the right eyepiece optical system each include the plurality of single lenses, and
an image magnification upon observation by both eyes is twice or more.
